(19) United States
(12) Patent Application Publication
(10) Pub. No.: US 2012/0297114 A1
(43) Pub. Date: Nov. 22, 2012

(54) STORAGE CONTROL APPARATUS AND MANAGMENT METHOD FOR SEMICONDUCTOR-TYPE STORAGE DEVICE

(75) Inventors: Yoshiharu Koizumi, Hadano (JP); Kiyoshi Honda, Yokohama (JP); Kazushi Sasaki, Hadano (JP); Keiichiro Uchida, Odawara (JP)

(73) Assignee: HITACHI, LTD., Tokyo (JP)

(21) Appl. No.: 13/131,938

(22) PCT Filed: May 19, 2011
(86) PCT No.: PCT/JP11/02796

§ 371 Date: May 31, 2011

(51) Int. Cl. G06F 12/00

(52) U.S. Cl. 711/103; 711/E12.008

(57) ABSTRACT

The present invention is provided for maintaining and replacing storage devices systematically in accordance with schedule. A storage control apparatus 1 has multiple storage devices 1A equipped with flash memory or the like. The storage control apparatus 1 monitors and records the utilization state of each storage device. When a storage device utilization state reaches a first threshold, the storage control apparatus starts an access control process to control the length of a maintenance period. When the storage device utilization state reaches a second threshold, the storage control apparatus executes blockage control, thereby causing this storage device to be replaced. The timing, at which a storage device with little lifetime remaining is replaced, is controlled to enhance maintenance work efficiency.

### TECHNICAL FIELD

The present invention relates to a storage control apparatus and a management method for a semiconductor-type storage device.

### BACKGROUND ART

A storage control apparatus, which controls multiple storage devices, for example, provides a host computer with a storage area based on RAID (Redundant Arrays of Inexpensive Disks). Hard disk drives are well known as storage devices, but a storage device (Solid State Drive) using flash memory have been introduced in recent years.

The flash memory is able to read and write data, and, in addition, will not lose data even when the power supply is shut off. The flash memory writes data in page units, and erases data in block units. The block unit is larger than the size of the page. The flash memory has limits with respect to number of erases and number of writes in accordance with the type of this memory. Either a write error or a read error can occur in a flash memory, which has reached the upper limit for number of erases.

Consequently, a technology for leveling the number of data erases between respective flash memories and extending the lifetime of these flash memories has been proposed for a case in which multiple types of flash memories having different numbers of data erases are used (Patent Literature 1).

### CITATION LIST

### Patent Literature

### [PTL 1]

Japanese Patent Application Laid-open No. 2010-108246

### SUMMARY OF INVENTION

### Technical Problem

In the prior art, the lifetime of the storage device as a whole is extended by optimizing the allocation between flash memory devices of blocks for which the number of data erases has reached the upper limit. However, because the number of data erases is being leveled, at a certain point, the lifetimes of multiple storage devices can end at the same time, causing multiple blockages to occur. Multiple blockages is a state in which multiple storage devices belonging to a single RAID group are blocked at the same time.

In a case where the lifetime of a storage device suddenly ends one day, it is not possible to erase the data stored in this storage device by sending the storage device an erase command. In this case, the data stored in this storage device is prevented from leaking outside by physically destroying the storage device whose lifetime ended. Physically destroying the storage device makes it impossible to reuse the relatively expensive flash memory, increasing operating costs.

There is also a method whereby the storage device is replaced prior to the lifetime of the storage device ending. In this case, a storage device for which the number of data erases has exceeded a threshold is shut down and removed from the system as a preventive maintenance measure. A threshold with sufficient leeway must be stipulated for enhanced security. However, replacing a relatively expensive flash memory well before its lifetime is over increases system operating costs.

With the foregoing problems in view, an object of the present invention is to provide a storage control apparatus and a management method for a semiconductor-type storage device for enabling maintenance work to be performed systematically. Another object of the present invention is to provide a storage control apparatus and a management method for a semiconductor-type storage device for enabling maintenance to be performed systematically on multiple storage devices having different lifetimes, and for making it possible to improve the efficiency of maintenance work.

### Solution to Problem

A storage control apparatus of one aspect of the present invention controls multiple semiconductor-type storage devices and comprises a microprocessor, a memory is used by the microprocessor, a first communication interface circuit for communicating with a host computer, and a second communication interface circuit for communicating with the multiple storage devices, wherein the microprocessor establishes respectively a utilization state management part for managing the utilization states of multiple storage devices by executing a prescribed computer program stored in the memory, a period adjusting part for extracting, from among multiple storage devices, a first storage device, which matches a preset first state and controlling a prescribed period during which the extracted first storage device reaches a preset second state, based on the utilization states of the multiple storage devices managed by the utilization state management part, and a blockage processing part for extracting, from among the multiple storage devices, a second storage device, which matches a second state, and blocking the extracted second storage device.

The period adjusting part can extract multiple first storage devices in preset group units from among the multiple storage devices. The period adjusting part can control the prescribed period for each of the multiple first storage devices extracted in group units.

The period adjusting part determines whether the prescribed period, during which the first storage device reaches the second state, is earlier or later than a preset reference period. In a case where the prescribed period is later than the reference period, the period adjusting part can execute a first control process for controlling the utilization state of the first storage device to expedite the prescribed period. In a case where the prescribed period is earlier than the reference period, the period adjusting part can execute a second control process for controlling the utilization state of the first storage device delay the prescribed period.

The period adjusting part, in a case where either the first control process or the second control process is being executed for another first storage device, can also execute either the first control process or the second control process executed for the first storage device so that the other prescribed period for the other first storage device matches the prescribed period for the first storage device.

The first control process can detect another storage device with a higher utilization frequency than the first storage device, and can interchange data between the other storage device with the higher-utilization-frequency and the first storage device. The second control process can detect another storage device with a lower utilization frequency than the first storage device, and can interchange data between the lower-utilization-frequency other storage device and the first storage device.

The first control process can change the RAID groups to which the first storage device and the other storage device with the higher-utilization-frequency respectively belong. The second control process can change the RAID groups to which the first storage device and the lower-utilization-frequency other storage device respectively belong.

A management method according to another aspect of the present invention manages the lifetimes of multiple semiconductor-type storage devices in accordance with a storage control apparatus, the storage control apparatus has a microprocessor, and a memory, which is utilized by the microprocessor, wherein in accordance with the microprocessor carrying out a prescribed computer program stored in the memory, the method executes: managing the utilization states of multiple storage devices; setting a second threshold in accordance with the type of the multiple storage devices; setting a first threshold based on the second threshold, a specified maintenance period, and a utilization state history; determining whether or not a first storage device for which the utilization state value has reached the first threshold exists among the multiple storage devices; computing, in a case where the first storage device exists, a prescribed period until the utilization state value of the first storage device reaches the second threshold; comparing the computed prescribed period with a preset reference period; executing, in a case where the prescribed period is later than the reference period, a first control process for controlling the utilization state value of the first storage device to expedite the prescribed period; and executing, in a case where the prescribed period is earlier than the reference period, a second control process for controlling the utilization state value of the first storage device to delay the prescribed period; determining whether or not a second storage device, for which the utilization state value has reached the second threshold, exists among the first storage devices; and erasing, in a case where the second storage device exists, the data inside the second storage device; and blocking the second storage device from which the data has been erased.

### BRIEF DESCRIPTION OF DRAWINGS

FIG. 1 is an illustrative drawing schematically showing the overall concept of the embodiment.

FIG. 2 is a block diagram of an entire computer system comprising a storage control apparatus.

FIG. 3 is an illustrative drawing showing the relationship between a storage device and a RAID group.

FIG. 4 is an illustrative drawing showing the relationship between a logical address and a physical address.

FIG. 5 is a diagram showing the configuration of an address management table.

FIG. 6 is a diagram showing the configuration of a drive management table.

FIG. 7 is a diagram showing the configuration of a SSD management table.

FIG. 8 is a diagram showing the configuration of a maintenance setup screen.

FIG. 9 is a diagram showing the configuration of a maintenance management information table.

FIG. 10 is a diagram showing the configuration of information for managing the lifetime of a SSD.

FIG. 11 is a characteristics diagram showing the relationship between an error occurrence trend and a threshold.

FIG. 12 is a flowchart of a read process.

FIG. 13 is a flowchart of a write process.

FIG. 14 is a flowchart of a regular monitoring process.

FIG. 15 is a flowchart of a process for managing the lifetime of a SSD.

FIG. 16 is a flowchart showing the access control process of FIG. 15.

FIG. 17 is an illustrative drawing schematically showing access control.

FIG. 18 is a flowchart of high-load access control in FIG. 16.

FIG. 19 is an illustrative drawing showing how to interchange a target storage device with another storage device inside another RAID group.

FIG. 20 is a flowchart of low-load access control in FIG. 16.

FIG. 21 is a flowchart of blockage process in FIG. 15.

FIG. 22 is a flowchart of an access control process related to a second example.

FIG. 23 is an illustrative drawing showing how to execute a follow-on access control process in accordance with a preceding access control process.

### DESCRIPTION OF EMBODIMENT

The embodiment of the present invention will be explained below by referring to the attached drawings. However, it should be noted that this embodiment is simply an example for realizing the present invention, and does not limit the technical scope of the present invention.

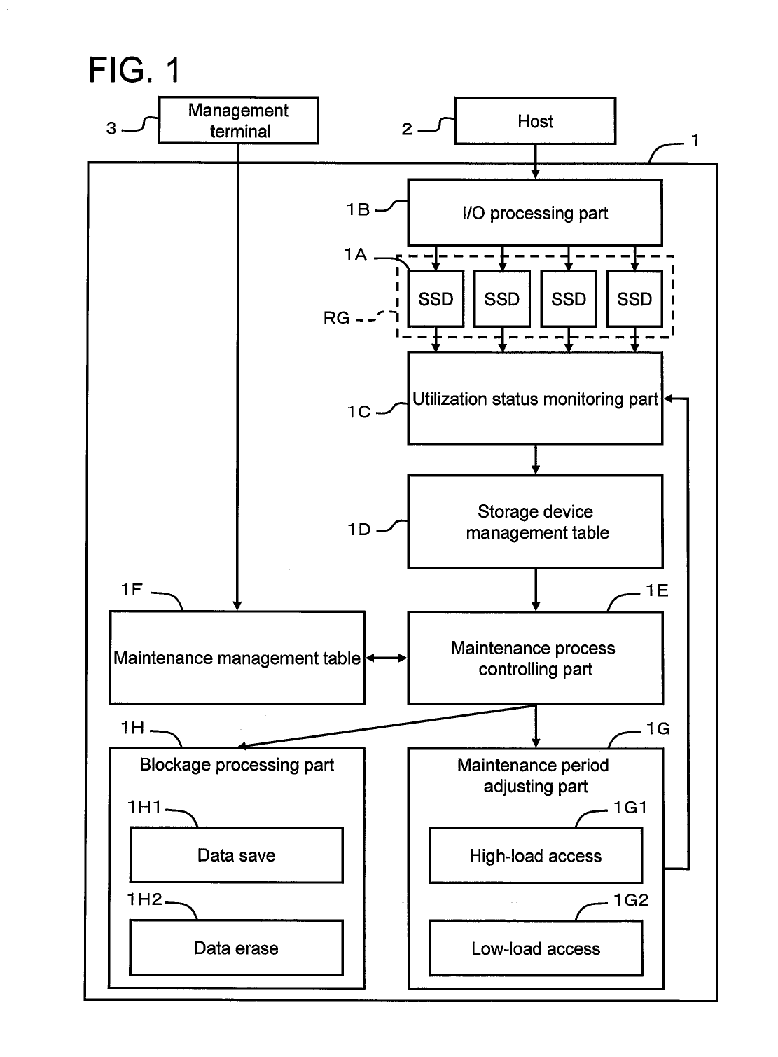

FIG. 1 shows the overall concept of the embodiment. A computer system, for example, comprises at least one storage control apparatus 1, at least one host computer (hereinafter, the host) 2, and at least one management terminal 3.

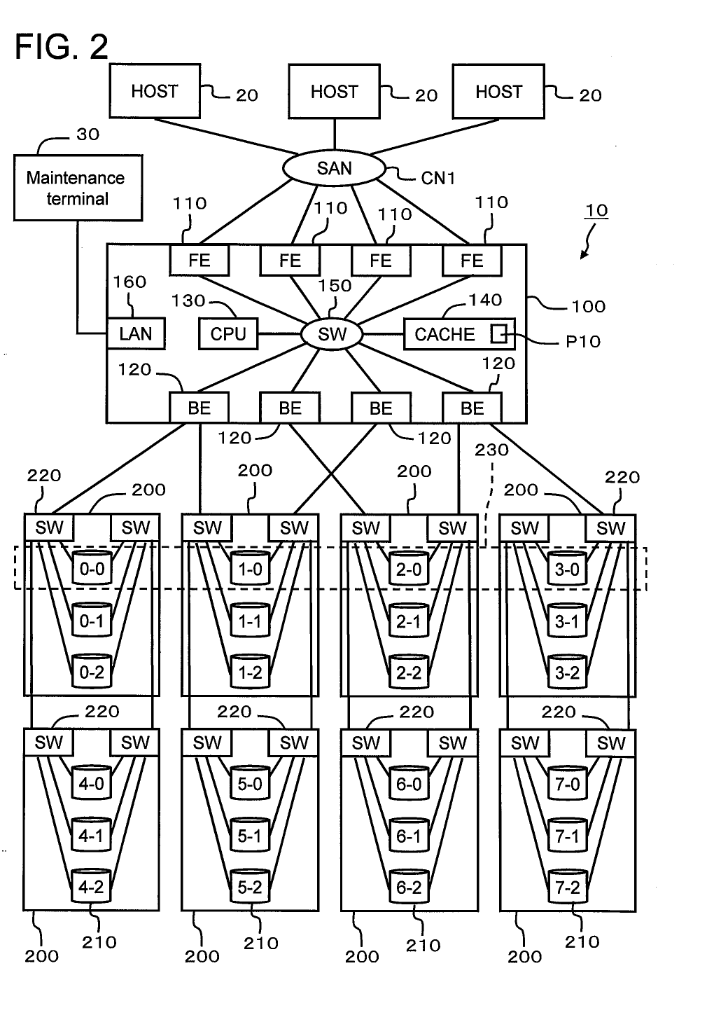

The storage control apparatus 1 comprises multiple storage devices (SSD) 1A, and at least one controller (Omitted in FIG. 1; refer to controller 100 of FIG. 2.). The controller, for example, comprises an I/O (Input/Output) processing part 1B, a utilization state monitoring part 1C, a storage device management table 1D, a maintenance process controlling part 1E, a maintenance management table 1F, a maintenance period adjusting part 1G, and a blockage processing part 1H.

The I/O processing part 1B processes a write command and a read command from the host 2, and reads/writes data from/to the storage device 1A.

The storage device 1A, for example, is configured as a semiconductor-type storage device equipped with a flash memory. For example, a single RAID group RG can be configured from multiple storage devices 1A. A RAID group RG puts together and manages, as a group, physical storage areas of each of multiple storage devices 1A. The grouped physical storage areas can be used to provide a logical storage area (logical volume). The host 2 accesses the logical volume to read/write data.

The I/O processing part 1B analyzes a command received from the host 2, and converts the logical address included in this command to a physical address. The logical address is information for identifying a location inside the logical volume. The physical address is information showing the location in which data specified by the logical address is actually stored. The I/O processing part 1B reads/writes data from/to the storage device 1A in accordance with the command.

The result of a data read/write to each storage device 1A by the I/O processing part 1B is recorded in the storage device management table 1D. The storage device management table 1D stores a utilization state history of each storage device 1A. The utilization state is information related to the utilization of the storage device 1A, and, for example, includes a data write count, a data erase count, a number of times that a write error has occurred (hereinafter, the write error count), a number of times that a read error has occurred (hereinafter, the read error count), and a number of unreadable pages (hereinafter, the BAD count). As mentioned above, the information showing the utilization state can be divided into information related to the lifetime of the storage device 1A (the data write count and the data erase count) and information related to the reliability of the storage device 1A (the write error count, the read error count, and the BAD count).

The maintenance process controlling part 1E refers to the contents of the maintenance management table 1F and is in charge of control related to storage device 1A maintenance work. A user, such as the system administrator, accesses the storage control apparatus 1 via the management terminal 3, and sets the contents of the maintenance management table 1F.

For example, a maintenance period, a monitoring-targeted error, and a monitoring interval are set in the maintenance management table for each RAID group RG. The maintenance period is information showing the time for replacing the storage device 1A. For example, in a case where “one week” has been set as the maintenance period value, the storage device 1A is replaced within one week from the installation date thereof. The monitoring-targeted error is an error selected to set the stage for the start of processing of maintenance and replacement. The monitoring-targeted error can include the data erase count, the write error count, the read error count, and the BAD count. The monitoring interval is the period during which monitoring for a monitoring-targeted error is performed.

The maintenance process controlling part 1E sets two types of states. A first state is state in which a prescribed utilization state value has reached a first threshold. The prescribed utilization state is an error that has been set beforehand as a monitoring target. The first threshold Th1 is set for detecting a storage device 1A that is approaching a maintenance replacement time.

A second state is a state in which a prescribed utilization state has reached a second threshold. The second threshold Th2 is set for stipulating the time at which maintenance replacement should be performed. That is, the storage device 1A for which the prescribed utilization state (monitoring-targeted error) value has reached the second threshold is removed from the storage control apparatus 1 and replaced with a new storage device 1A.

The maintenance process controlling part 1E executes a process for adjusting the maintenance period with respect to a first state storage device 1A (a first storage device 1A). In addition, the maintenance process controlling part 1E executes a blockage process with respect to a second state storage device 1A (a second storage device 1A).

The maintenance period adjusting part 1G adjusts the maintenance period of the first storage device 1A. The maintenance period of the first storage device 1A will differ in accordance with the type of the storage device 1A. For example, a storage device 1A to be mounted to a storage control apparatus of a quality model will have a long lifetime (upper value). Meanwhile, a storage device 1A to be mounted to storage control apparatus of an inexpensive model will have a short lifetime.

In addition, there will be individual differences in actual lifetimes even for storage devices 1A of the same type. For example, one storage device 1A has a high frequency of errors, and another storage device 1A of the same type as the one storage device has a low frequency of errors. In this case, the one storage device 1A will reach the upper limit value (the second threshold) sooner than the other storage device 1A. The other storage device 1A may be replaced after having replaced the one storage device 1A, but doing so is troublesome in that it requires that maintenance work be performed two times.

Therefore, the maintenance period adjusting part 1G individually adjusts the maintenance periods of the respective storage devices 1A based on a predetermined reference period for each type of storage device 1A. For example, high-load access control is implemented to make intensive use of the other storage device 1A that exhibits fewer error occurrences. The high-load access control is for increasing the number of accesses. In accordance with this, the lifetime of the other storage device 1A is shortened compared to prior to executing the high-load access control. That is, the time until the prescribed utilization state value of the other storage device 1A reaches the second threshold is shortened.

Alternatively, a low-load access control is implemented for the one storage device 1A with a high frequency of errors. The low-load access control is for reducing the number of accesses. In accordance with this, the lifetime of the one storage device 1A becomes longer compared to prior to executing the low-load access control. That is, the time until the prescribed utilization state value of the one storage device 1A reaches the second threshold is lengthened.

The blockage processing part 1H subjects the second storage device 1A for which the prescribed utilization state value has reached the second threshold to a blockage process. The blockage processing part 1H, for example, comprises a data save process 1H1 and a data erase process 1H2.

The data save process 1H1 saves data stored in a storage device (a second storage device), which is the blockage target, to a spare storage device 1A as a copy. A storage device 1A, which is an unused storage device 1A, and, in addition, comprises a storage size, which is equal to or larger than the storage size of the blockage-targeted storage device, is selected as a spare storage device.

The data erase process 1H2 issues a data erase command to the storage device 1A, which is the blockage target, and erases the data stored in this storage device 1A. It is preferable that all the data in this storage device 1A be able to be erased by the data erase command. However, since secrets should be able to be retained, the scope of the present invention also includes a case in which a portion of the data of the storage device 1A will remain.

Furthermore, the data erase process 1H2 is carried out even when the data save process 1H1 has not been completed for the blockage-targeted storage device 1A. The data of the blockage-targeted storage device 1A is erased even when there is no spare storage device. Thereafter, the storage device 1A is blocked and removed from the storage control apparatus 1.

In a case where security takes precedence, the data of this blockage-targeted storage device 1A is deleted without the data save process 1H1 being performed. That is, the data of the blockage-targeted storage device 1A is deleted even in a case where there is no spare storage device 1A.

The erased data can be restored using a correction copy subsequent to the new storage device 1A being installed in the storage control apparatus 1. The correction copy is a technique for reproducing lost data based on the data and a parity stored in other storage devices 1A belonging to the same RAID group. Therefore, in a case where data redundancy is assured using RAID, a delete may be carried out without saving the data of either one or multiple storage devices 1A inside the RAID group. In the case of RAID 5, even in a case where the data of one storage device 1A has been erased, the erased data can be restored using the data and parity of the other storage devices 1A. In the case of RAID 6, even in a case where the data of two storage devices 1A has been erased, the erased data can be respectively restored using the data and parity of the other storage devices 1A.

The data save process 1H1 and the data erase process 1H2 are executed so that RAID-based data redundancy is not lost. For example, in a case where two storage devices 1A are targeted for blockage in a RAID 5 group, the data of at least one of these two storage devices 1A is copied to the spare storage device. In a case where the spare storage device does not exist, a warning can also be issued to the system administrator.

In this embodiment, which is configured like this, processes 1G1 and 1G2 for controlling the maintenance period are carried out when the utilization state value of the storage device 1A reaches the first threshold Th1. That is, in this embodiment, maintenance periods are set in group RG units, and the maintenance period is adjusted for each storage device 1A included in this group RG. Therefore, the efficiency of maintenance work can be increased by making the maintenance replacement times of the storage devices 1A inside the same group RG identical.

In this embodiment, the first threshold Th1 is set prior to the second threshold Th2, which denotes the maintenance replacement time (lifetime), and when the utilization state value of the storage device 1A reaches the first threshold Th1, lifetime management (access control processing) is executed. Therefore, maintenance work can be systematically carried out prior to the storage device 1A suddenly stopping. This enhances the reliability of the storage control apparatus 1.

In this embodiment, the storage device 1A can be used until the lifetime of this storage device 1A runs out (the second threshold Th2). Therefore, the frequency of maintenance replacement can be lessened, and the operating costs of the storage control apparatus 1 can be reduced.

Since maintenance work can be systematically carried out in this embodiment, the data of a storage device 1A can be erased prior to replacement. Therefore, there is no need to physically destroy a replacement-targeted storage device 1A (a blockage-targeted storage device) for security purposes. This makes it possible to reuse a replacement-targeted storage device 1A, and to reduce the operating costs of the storage control apparatus 1. This embodiment will be explained in more detail below.

### Example 1

A first example will be explained by referring to FIGS. 2 through 21. First, by way of describing the relationship with FIG. 1, the storage control apparatus 10 corresponds to the storage control apparatus 1 of FIG. 1, the host 20 corresponds to the host 2 of FIG. 1, the maintenance terminal 30 corresponds to the management terminal 3 of FIG. 1, and the storage device 210 corresponds to the storage device 1A of FIG. 1. The controller 100 of FIG. 2 realizes the respective functions (or management information) 1B, 1C, 1D, 1E, 1F, 1G and 1H of FIG. 1.

As shown in the block diagram of the entire computer system of FIG. 2, the computer system, for example, comprises at least one storage control apparatus 10, at least one host 20, and at least one maintenance terminal 30. The storage control apparatus 10 and the respective hosts 20, for example, are coupled via a communication network CN1 like either a FC-SAN (Fibre Channel-Storage Area Network) or an IP-SAN (Internet Protocol-SAN) so as to enable two-way communications. The storage control apparatus 10 and the maintenance terminal 30, for example, are coupled via a LAN (Local Area Network).

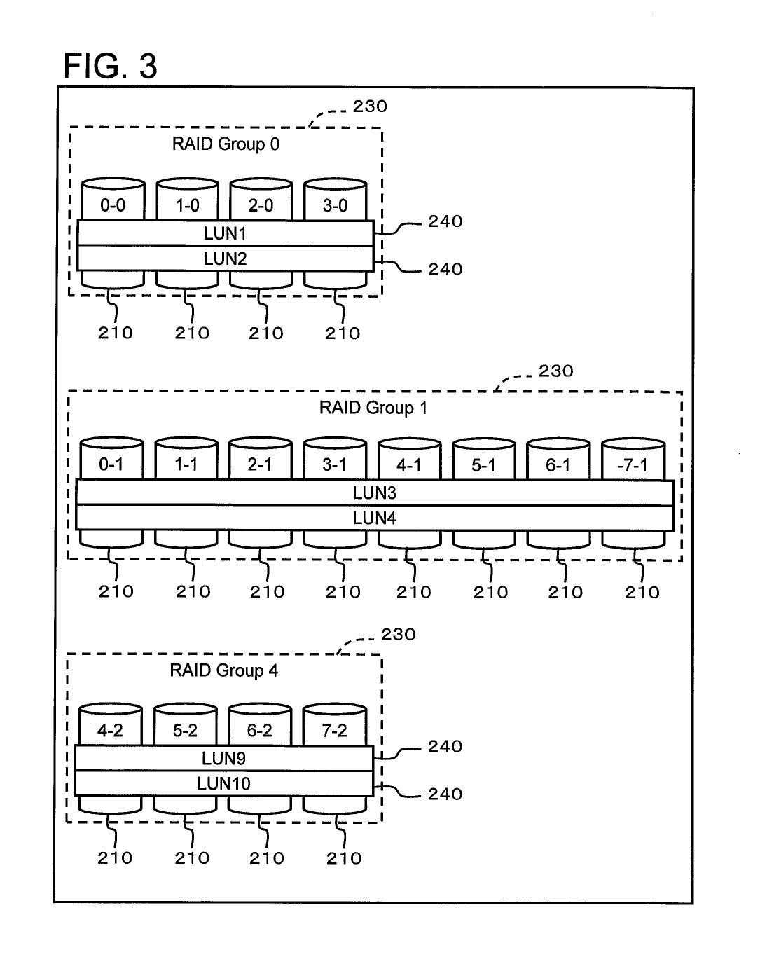

The host 20, for example, is configured like either a server computer or a mainframe computer. The host 20 reads/writes data using a logical volume 240 (refer to FIG. 3) provided by the storage control apparatus 10.

The maintenance terminal 30 reads the internal state of the storage control apparatus 10, sets the storage control apparatus 10 configuration and so forth, and issues an instruction to the storage control apparatus 10. In this example, a user, such as the system administrator, uses the maintenance terminal 30 to perform settings for maintenance work. The maintenance terminal 30, for example, can comprise a notebook, tablet or other such personal computer, a personal data assistant, or a mobile telephone.

The storage control apparatus 10, for example, comprises at least one controller 100, and multiple drive boxes 200. The controller 100 is a device for controlling the operation of the storage control apparatus 10. Multiple controllers 100 may be provided to achieve a redundant configuration. That is, the configuration may be such that even in a case where either one of the controllers 100 should stop, the other controller 100 can control the operation of the storage control apparatus 10.

The controller 100, for example, comprises a front end communication interface part 110, a backend communication interface part 120, a microprocessor 130, a cache memory 140, a switching circuit 150, and a LAN port 160.

The front end communication interface part 110 (hereinafter, the FE I/F 110) is equivalent to the “first communication interface circuit”. The FE I/F 110 communicates with the host 20 via the communication network CN1.

The backend communication interface part 120 (hereinafter, the BE I/F 120) is equivalent to the “second communication interface circuit”. The BE I/F 120 communicates with the respective storage devices 210 inside the drive box 200. Although omitted from the drawing, the FE I/F 110 and the BE I/F 120 each comprise a microprocessor, a local memory, and a communication circuit.

The microprocessor 130 realizes a command process and a maintenance-related process in accordance with reading and executing a prescribed computer program P10 stored in the cache memory 140. The cache memory 140 temporarily stores data (write data) received from the host 20, and data (read data) read from the storage device 210. The cache memory 140 also stores various types of management information, which will be described further below.

The switching circuit 150 mutually couples the FE I/F 110, the BE I/F 120, the microprocessor 130, and the cache memory 140. Furthermore, the LAN port 160 is a communication interface circuit for coupling the maintenance terminal 30 and the controller 100.

The drive box 200 houses multiple storage devices 210. The drive box 200 is provided with multiple storage devices 210, a switching circuit 220 for accessing these storage devices 210, and a power source device (not shown in the drawing).

The storage device 210, for example, is configured as a storage device equipped with flash memory or other such semiconductor storage element. The present invention is not limited to this configuration, and may be configured using other semiconductor storage elements besides a flash memory. In the drawing, the physical locations of the respective storage devices 210, for example, like “0-0” and “4-2”, are shown in a matrix. There may be cases where the storage device 210 is displayed as SSD.

FIG. 3 schematically shows the configurations of storage areas. For example, a single RAID group 230 is configured from multiple storage devices 210. The RAID group RG 230 puts together and manages, as a group, physical storage areas of each storage devices 210. Either one or multiple logical storage areas 240 can be created using the physical storage areas grouped together in accordance with the RAID group 230. The logical storage area is also called a logical volume. A LUN (Logical Unit Number) is associated with the logical volume 240. The host 20 accesses the logical volume 240 allocated to itself to read/write data.

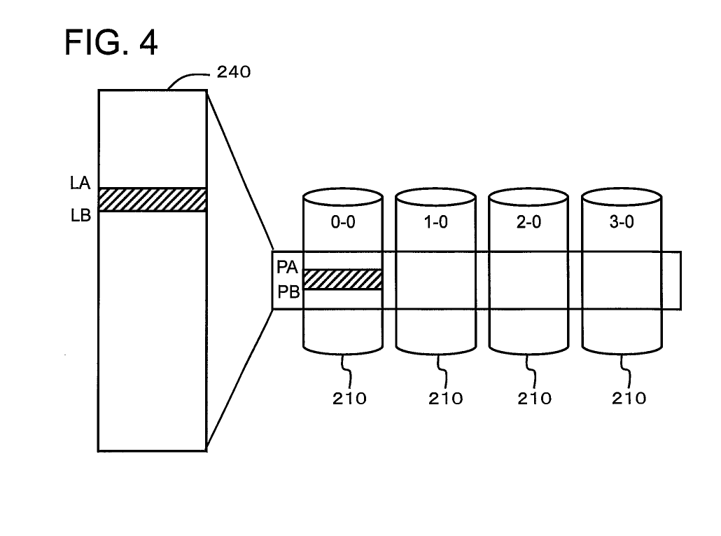

FIG. 4 schematically shows the relationship between a physical address and a logical address. A logical address inside the logical volume 240 is included in either a read command or a write command issued from the host 20.

In FIG. 4, for example, it is assumed that the host 20 accesses a range of addresses from a first logical address LA to a last logical address LB. A LUN, the first logical address LA, and a data size are specified in a command received from the host 20. The BE I/F 120 of the controller 100 identifies the RAID group 230 based on the LUN, and, in addition, computes a physical address based on the first logical address and the data size. In accordance with this, it is learned that the range from the logical address LA to the logical address LB corresponds to the range of addresses from physical address PA to physical address PB. The BE I/F 120 reads/writes data by accessing the computed physical address. The FE I/F 110 sends the result of command processing to the host 20.

Furthermore, the unit for accessing the storage device 210 is a page, and the data erase unit of the storage device 210 is a block. As an example, the page size is four kilobytes and the block size is 256 kilobytes. The block size is tens of times larger than the page size.

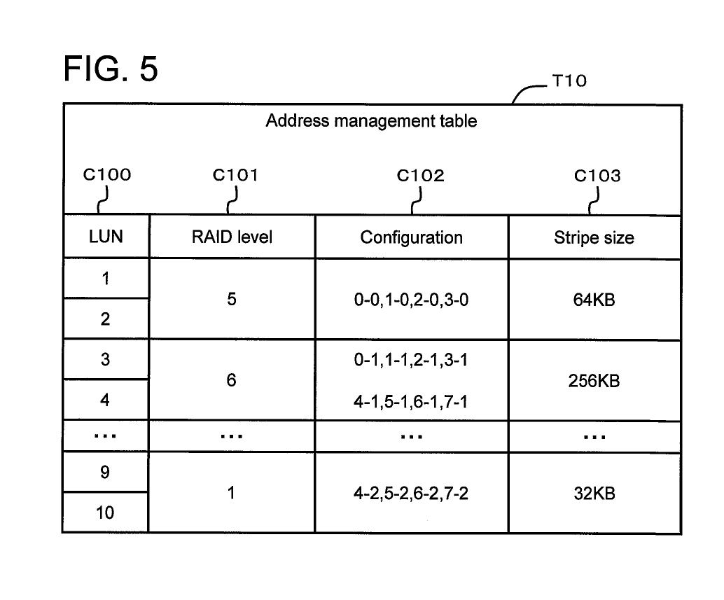

FIG. 5 shows an example of the configuration of an address management table T10. The address management table T10 is for managing information for accessing a storage device 210 inside a RAID group 230.

The address management table T10, for example, correspondingly manages a LUN C100, a RAID level C101, a configuration C102, and a stripe size C103.

The LUN C100 shows the LUN set in the logical volume 240, which is the access destination. The RAID level C101 shows the RAID level of the access-destination logical volume 240. For example, RAID 1, 5, 6 and so forth are used relatively often as RAID levels. The configuration C102 shows the location number of the storage device 210 included in the RAID group 230 to which the access-destination logical volume 240 belongs. The stripe size C103 shows the size of the data distributively stored in the respective storage devices 210.

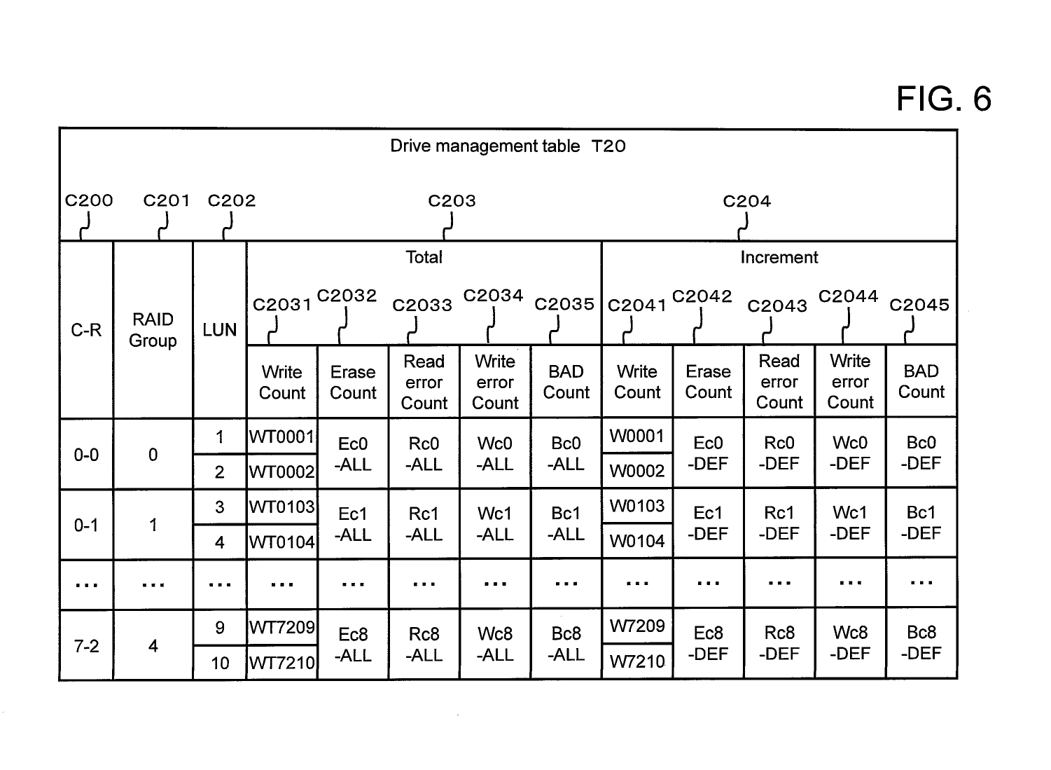

FIG. 6 shows an example of the configuration of a drive management table T20. The drive is the storage device 210. The drive management table T20 manages the utilization state of each storage device 210 under the control of the storage control apparatus 10. The drive management table T20 corresponds to the storage device management table 1D of FIG. 1.

The drive management table T20, for example, correspondingly manages an installed location (C-R in the drawing) C200, a RAID group number C201, a LUN C202, a total value of each utilization state C203, and an increment in value of each utilization state C204.

The installed location C200 shows the location in which a drive box 200 is installed in a matrix. The system administrator or maintenance technician can immediately identify a replacement-targeted storage device 210 by checking the installed location C200.

The RAID group number C201 is information for identifying a RAID group 230 to which a storage device 210 belongs. The LUN C202 shows the LUN set for the logical volume 240 provided by the RAID group 230.

The total value of each utilization state C203 stores the cumulative value of each utilization state. The utilization state, for example, can include the write count C2031, the data erase count C2032, the read error count C2033, the write error count C2034, and the BAD count C2035.

The write count C2031 is managed for each logical volume 240 related to a storage device 210. The data erase count C2032, the read error count C2033, the write error count C2034, and the BAD count C2035 are managed for each storage device 210.

The increment in value of each utilization state C204 stores the increment from the previous time of each of the utilization states described hereinabove. The increment C204 manages a write count added from the previous time C2041, a data erase count added from the previous time C2042, a read error count added from the previous time C2043, a write error count added from the previous time C2044, and a BAD count added from the previous time C2045. The write count C2041 is managed for each logical volume 240 related to a storage device 210. The other utilization states C2042 through C2045 are managed in storage device 210 units.

Furthermore, only one increment C204 for the previous time is shown in FIG. 6, but a larger history can also be stored. However, the more utilization state histories remain, the more cache memory 140 storage area is consumed.

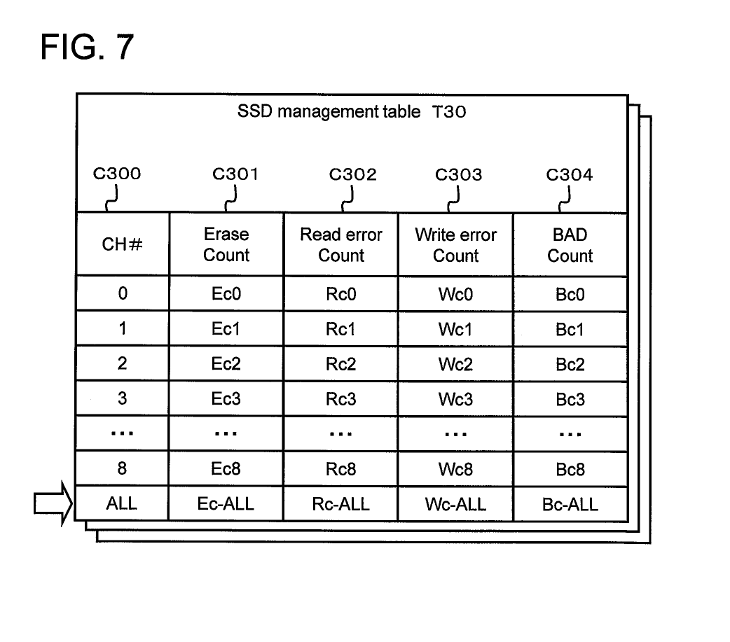

FIG. 7 shows an example of the configuration of a SSD management table T30. The SSD management table T30 is prepared for each storage device 210. SSD is the storage device 210. Each storage device 210 comprises multiple channels, and a flash memory is provided in each channel.

The SSD management table T30, for example, comprises a channel number C300, a data erase count C301, a read error count C302, a write error count C303, and a BAD count C304.

The channel number C300 is information for identifying the above-mentioned respective channels inside the storage device 210. The data erase count C301 shows the number of data erases that have occurred in the relevant channel (flash memory). The read error count C302 shows the number of read errors that have occurred in the relevant channel. The write error count C303 shows the number of write errors that have occurred in the relevant channel. The BAD count C304 shows the number of BAD that have occurred in the relevant channel.

A total row is disposed at the bottom of the SSD management table T30. The total row shows values, which respectively total the values of each utilization state of each channel. The values of the total row show the utilization states produced by a single storage device 210. The values of the SSD management table T30 total row for each storage device 210 are stored in the drive management table T20 at a prescribed cycle.

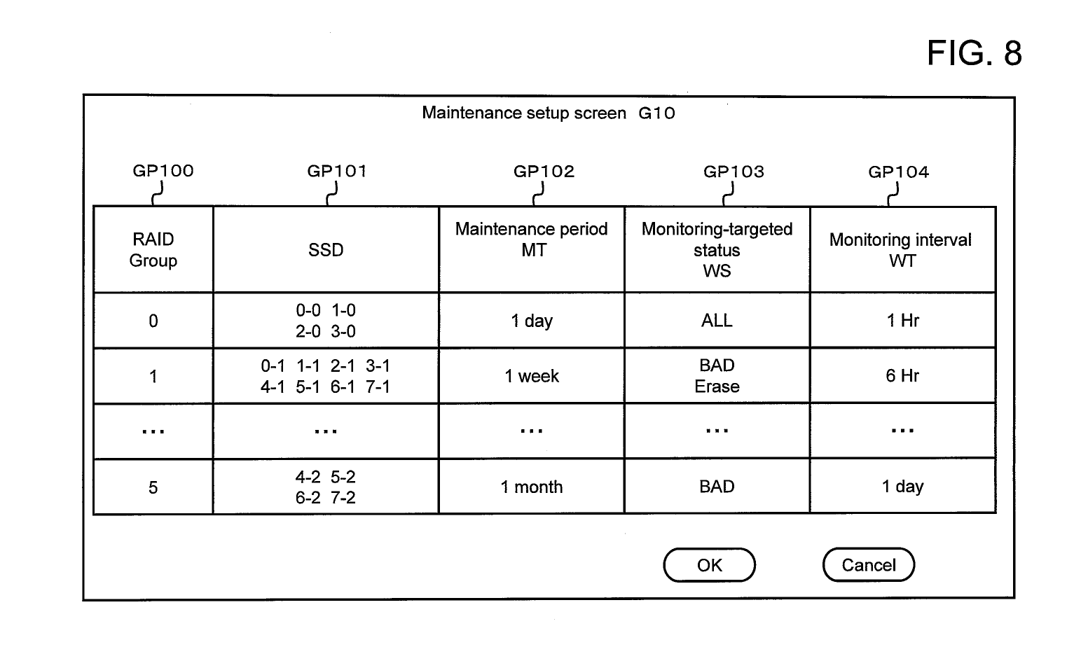

FIG. 8 shows an example of the configuration of a maintenance setup screen G10. The maintenance setup screen G10 is displayed on the screen of the maintenance terminal 30. The screen shown G10 in FIG. 8 is displayed when the maintenance terminal 30 logs in to a server (not shown in the drawing) inside the storage control apparatus 10 and selects a maintenance setup menu.

The maintenance setup screen G10 comprises multiple display parts GP100 through GP104. A RAID group number display part GP100 displays the number of a RAID group 230. A SSD configuration display part GP101 displays information for identifying the storage device (s) 210 that configure the RAID group 230. The installed location of a storage device 210 is used as information for identifying the storage device 210.

A maintenance period display part GP102 displays a maintenance period. In the drawing, maintenance period may be abbreviated as MT. The maintenance period is the time until the respective storage devices 210 inside a RAID group are replaced. The maintenance period, for example, can be specified in units of days, weeks, or months, as in one day, one week or one month. In a case where the maintenance period is specified as “one month”, the storage device(s) 210 comprising the relevant RAID group 230 is/are to be replaced after one month from the specified day.

Whether or not the maintenance period is strictly adhered to will depend on the maintenance work operation policy. The storage device 210 may be replaced at the end of the maintenance period by strictly following the maintenance plan, or the storage device 210 may be replaced prior to the passage of the maintenance period. In addition, in some cases, the storage device 210 may be replaced after the maintenance period has elapsed. However, an operation to replace the storage device 210 after the lapse of the maintenance period is not preferred since it raises the risk of not being able to perform a data erase. Therefore, in this example, it is supposed that the storage device 210 is replaced either before the specified maintenance period ends, or at the same time that the maintenance period ends.

A monitoring-targeted state display part GP103 displays the state of a monitoring target. In the drawing, the monitoring-targeted state may be abbreviated as WS. The monitoring-targeted state is equivalent to either the “prescribed utilization state” or the “utilization state”.

The monitoring-targeted state can include the four states of the data erase count, the read error count, the write error count and the BAD count managed by the SSD management table T30. All four of these states may be monitoring targets, or either one, two, or three of these four states may be the monitoring state. The write count is not selected as a monitoring-targeted state. In some cases, the configuration may be such that the write count is added to the monitoring targets.

A relationship can also be established between the monitoring-targeted state and the maintenance period. For example, the maintenance setting can be made such that a shorter maintenance period increases the types of monitoring-targeted states, and a longer maintenance period decreases the types of monitoring-targeted states.

In the example of FIG. 8, in a case where the maintenance period is set to a short period of time like “one day”, all of the above-mentioned four types of states can be targeted for monitoring. Since a short maintenance period has been set, storage device 210 changes must be detected more accurately. When any one of the four states targeted for monitoring reaches the first threshold Th1, the access control described hereinbelow is started.

In a case where the maintenance period is set to a long period of time like “one month”, only one of the above-mentioned four types of states may be set as the monitoring target. Since there is a lot of time until maintenance replacement, only one state is targeted for monitoring, the thinking being that the reliability of the storage device 210 will probably be very clearly revealed. The monitoring process load is reduced in accordance with this. In the example of FIG. 8, the BAD count, which impacts the reliability of the storage device 210 the most, is specified as the monitoring target. The BAD count shows the number of times that data could not be read from the access-targeted page. Therefore, the BAD count shows the reliability of the storage device 210 more clearly than the other states.

In a case where the maintenance period is set to a medium period of time like “one week”, either two or three of the above-mentioned four types of states can be set as the monitoring targets. The monitoring process load can be reduced by selecting the types of monitoring targets in accordance with the length of the maintenance period.

A monitoring interval GP104 displays a cycle for monitoring the monitoring-targeted states. In the drawing, the monitoring interval may be abbreviated as WT. The monitoring interval, for example, can be set as “every hour”, “every six hours”, or “every day”. The monitoring interval can also be set in accordance with the length of the maintenance period. For example, a shorter monitoring interval can be set the shorter the maintenance period is, and a longer monitoring interval can be set the longer the maintenance period is so that the monitoring frequency will not change that much. The monitoring process load can be reduced by setting the monitoring interval in accordance with the length of the maintenance period like this. Setting the type(s) of monitoring-targeted states and the monitoring interval in accordance with the length of the maintenance period make it possible to carry out the monitoring process more efficiently, and to reduce the processing load.

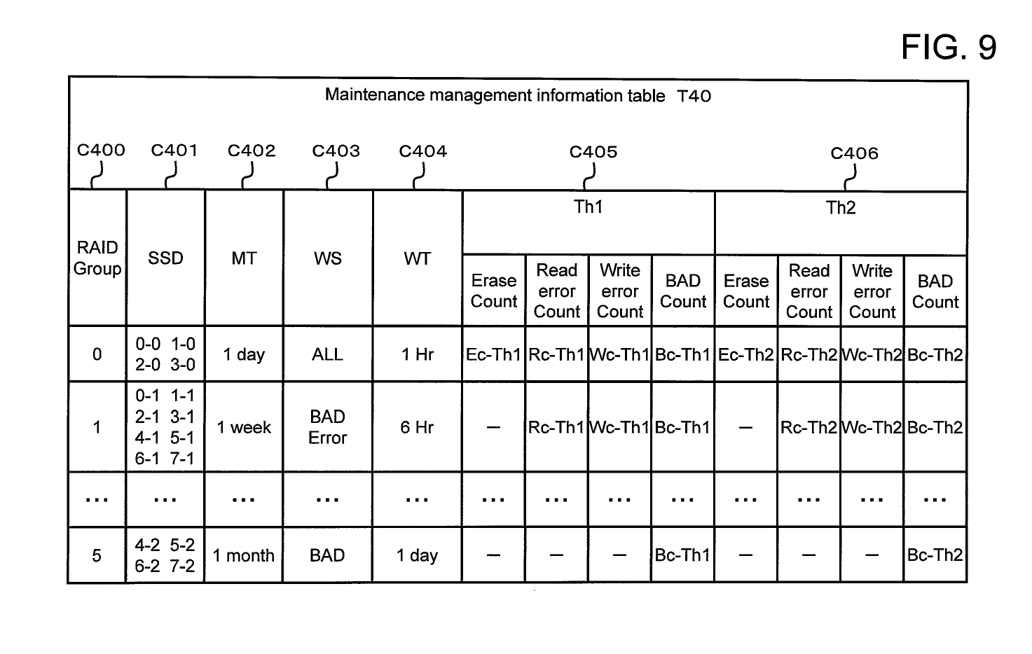

FIG. 9 shows an example of the configuration of a maintenance management information table T40. The maintenance management information table T40 is for managing the time period for storage device 210 maintenance work. The maintenance management information table T40 is created based on the contents of the maintenance setup screen G10 shown in FIG. 8. The maintenance management information table T40 corresponds to the maintenance management table 1F of FIG. 1.

The maintenance management information table T40, for example, correspondingly manages a RAID group number C400, a SSD configuration C401, a maintenance period C402, a monitoring-targeted state C403, a monitoring interval C404, a first threshold C405, and a second threshold C406.

The RAID group number C400 stores information for identifying a RAID group 230. The SSD configuration C401 stores information for identifying a storage device 210, which comprises a RAID group 230. The maintenance period C402 stores the maintenance period for each storage device 210.

The monitoring-targeted state C403 stores a state, which is targeted for monitoring as to whether or not this state has reached the first threshold Th1. The monitoring interval C404 stores a monitoring cycle. The first threshold C405 stores the first threshold Th1 value set for each monitoring-targeted state. The second threshold C406 stores the second threshold Th2 value set for each monitoring-targeted state.

As described using FIG. 1, the first threshold Th1 is used for selecting a storage device 210 that is approaching the maintenance replacement time. A storage device 210 (a first storage device 210), for which the value of any one or multiple monitoring-targeted states has reached the first threshold Th1, becomes the target of an access control process and is subjected to maintenance period adjustment.

The second threshold stipulates the end of the time period during which maintenance replacement is to be performed. The lifetime of the storage device 210 does not immediately end just because the value of the monitoring-targeted state reaches the second threshold. The storage device 210 can still be used for a longer period of time. This is because the second threshold Th2 is determined with a certain degree of leeway in accordance with the storage device 210 specifications and the like.

FIG. 9 will be explained more specifically. For example, in the row of RAID group number 0, “ALL” is set as the monitoring-targeted state. “ALL” is the setting value for making all four types of states, i.e. the data erase count, the read error count, the write error count, and the BAD count, the targets for monitoring. Therefore, in the columns of the first threshold C405, the first threshold Th1 is respectively set for each state. Similarly, the second threshold Th2 is respectively set for each state in the columns of the second threshold C406.

“BAD” and “Error” are set as the monitoring-targeted states in the RAID group number 1 row. “BAD” is the setting value for making the BAD count the monitoring target. “Error” is the setting value for making the read error count and the write error count the monitoring targets. In FIG. 9, for the sake of expedience, a case in which “Error” has been set is shown, but “Read Error” and “Write Error” may be set. In the columns of the first threshold C405, the first threshold Th1 is set for each of the read error count, the write error count, and the BAD count. Similarly, in the columns of the second threshold C406, the second threshold Th2 is set for each of the read error count, the write error count, and the BAD count.

Furthermore, no distinction is made in FIG. 9 for convenience sake, but the first threshold Th1 and the second threshold Th2 of each row may be the same or may differ. As will be explained further below, the second threshold Th2 is decided in accordance with the manufacturer, specifications, standards and so forth of the storage device 210. The second threshold Th2 is computed based on the value of the second threshold Th2, the maintenance period, and the gradient of a characteristics map specific to a storage device.

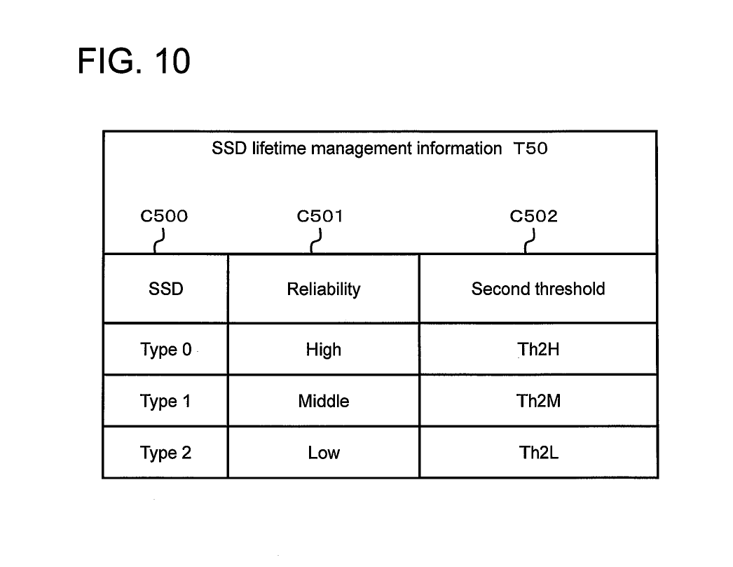

FIG. 10 is lifetime management information T50 for managing the lifetime of a SSD. That is, the lifetime management information T50 manages a specific second threshold Th2 for each type of storage device.

The lifetime management information T50, for example, correspondingly manages a storage device type C500, a storage device reliability C501, and a second threshold C502.

The type C500 shows the type of the storage device 210. In FIG. 10, for convenience of explanation, three types are shown, but many more types actually exist. The reliability C501 shows the reliability of each type of storage device 210. For example, reliability is managed in three levels in this example, i.e. “high”, “medium”, and “low”. A second threshold Th2 determined for each type of storage device 210 is set in the second threshold C502.

For convenience of explanation, only one second threshold Th2 is shown in the second threshold C502, but a second threshold Th2 can be set for each of the four monitoring-targeted states.

In the second threshold column C502 of each row, for example, a value is respectively set for each state, such as Th2 (for the data erase count), Th2 (for the read error count), Th2 (for the write error count), and Th2 (for the BAD count). The configuration may also be such that only one second threshold Th2 is set in the column C502, and the second threshold Th2 for each monitoring-targeted state is computed based on a predetermined formula.

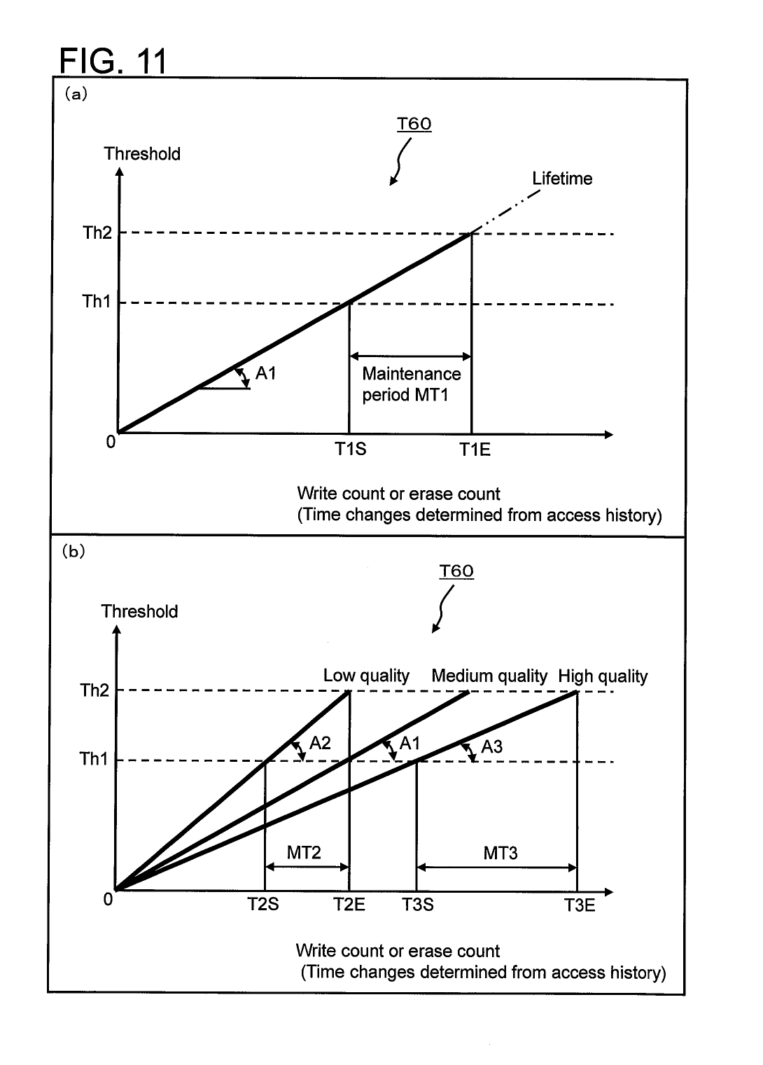

FIG. 11 is a characteristics map showing the relationship between the respective thresholds Th1 and Th2, and the maintenance period. The vertical axis of FIG. 11 shows the threshold value. The horizontal axis of FIG. 11 shows time changes determined from an access history of the storage device. For example, a write count or a data erase count is used as the access history. This is because either the write count or the data erase count constitutes an indicator for measuring the lifetime of the storage device 210. The history of either the write count or the data erase count, for example, can be obtained from the drive management table T20. The actual time that elapses per write count or data erase count will differ in accordance with how frequently the storage device 210 is accessed.

In FIG. 10, the difference in quality (performance) for each model is shown, but in FIG. 11, variations in quality in the same model will be explained. There will be slight variations in quality even in the same model of storage devices 210 resulting from various causes, and for this reason, the lifetimes thereof will also differ. Furthermore, it is conceivable that the variations in quality in the same model will be greater for low-end models and lesser for high-end models.

FIG. 11 (a) shows lifetime characteristics T60 of a medium-quality storage device 210, which will serve as the criterion. The vertical axis shows the threshold that is set for any of the monitoring-targeted states. The time at which the value of the monitoring-targeted state of the medium-quality storage device 210 reaches the first threshold Th1, that is, either the write count or the data erase count in a case where the value of the monitoring-targeted state has reached the first threshold Th1 will be T1S.

Either the write count or the data erase count in a case where the value of the monitoring-targeted state of the medium-quality storage device 210 has reached the second threshold Th2 will be T1E. The period from T1S until T1E is the maintenance period MT1. For example, in a case where “one week” has been set as the maintenance period MT1, the first threshold Th1 is determined by calculating backwards from the value of the second threshold Th2, which is the replacement lifetime. The amount of increase in one week can be computed from the access history of the storage device 210. Consequently, it is possible to find the first threshold Th1 by subtracting the increment within the maintenance period from the second threshold Th2. For example, in a case where the second threshold Th2 is 100,000, the maintenance period is one week, and the increment per day is 1,000, the first threshold Th1 is computed as 100,000−7×1,000=93,000.

Since the access frequency may also fluctuate, the value of the first threshold Th1 may not be a strictly accurate time. However, this is not a particular problem since the second threshold Th2 is set allowing for a certain degree of leeway. In addition, accuracy can be enhanced in the case of a configuration in which the first threshold Th1 is regularly revised on the basis of new access histories.

In FIG. 11 (b), the lifetime characteristics of a low-quality storage device, the lifetime characteristics of a medium-quality storage device, and the lifetime characteristics of a high-quality storage device are displayed. However, the low quality, medium quality, and high quality in FIG. 11 (b) shows the difference in quality in storage devices of the same type.

An explanation will be given using the medium-quality storage device as the criterion. A larger number of errors occurs in the low-quality storage device than in the medium-quality storage device even when both storage devices are used the same. The low-quality storage device will reach the end of its lifetime sooner than the medium-quality storage device. That is, the value of the monitoring-targeted state of the low-quality storage device 210 reaches the second threshold Th2 sooner. The rate A2 at which the value of the monitoring-targeted state of the low-quality storage device 210 increases is higher than the rate A1 at which the value of the monitoring-targeted state of the medium-quality storage device 210 increases. Therefore, the maintenance period MT2 of the low-quality storage device 210 is shorter than the maintenance period MT1 of the criterial medium-quality storage device 210. According to the above example, in a case where the criterial maintenance period MT1 is one week, the low-quality storage device 210 will reach the second threshold Th2 in a period MT2 that is shorter than that, i.e., either five or six days.

By contrast, a smaller number of errors occurs in a high-quality storage device than in the medium-quality storage device even when both storage devices are used the same. The high-quality storage device has a longer lifetime than the medium-quality storage device. That is, the value of the monitoring-targeted state of the high-quality storage device 210 reaches the second threshold Th2 more slowly. The rate A3 at which the value of the monitoring-targeted state of the high-quality storage device 210 increases is lower than the rate A1 at which that of the medium-quality storage device 210 increases. Therefore, the maintenance period MT3 of the high-quality storage device 210 is longer than the maintenance period MT1 of the criterial medium-quality storage device 210. According to the above example, the maintenance period MT3 of the high-quality storage device 210 will be longer than one week, i.e., either eight or nine days.

Despite belonging to the same RAID group 230, the low-quality storage device 210 will be replaced at an earlier time and the high-quality storage device 210 will be replaced at a later time. Therefore, maintenance replacement work must be performed each time, thereby lowering work efficiency. Consequently, in this example, the maintenance period is adjusted for each storage device 210, thereby improving the efficiency of the maintenance replacement work.

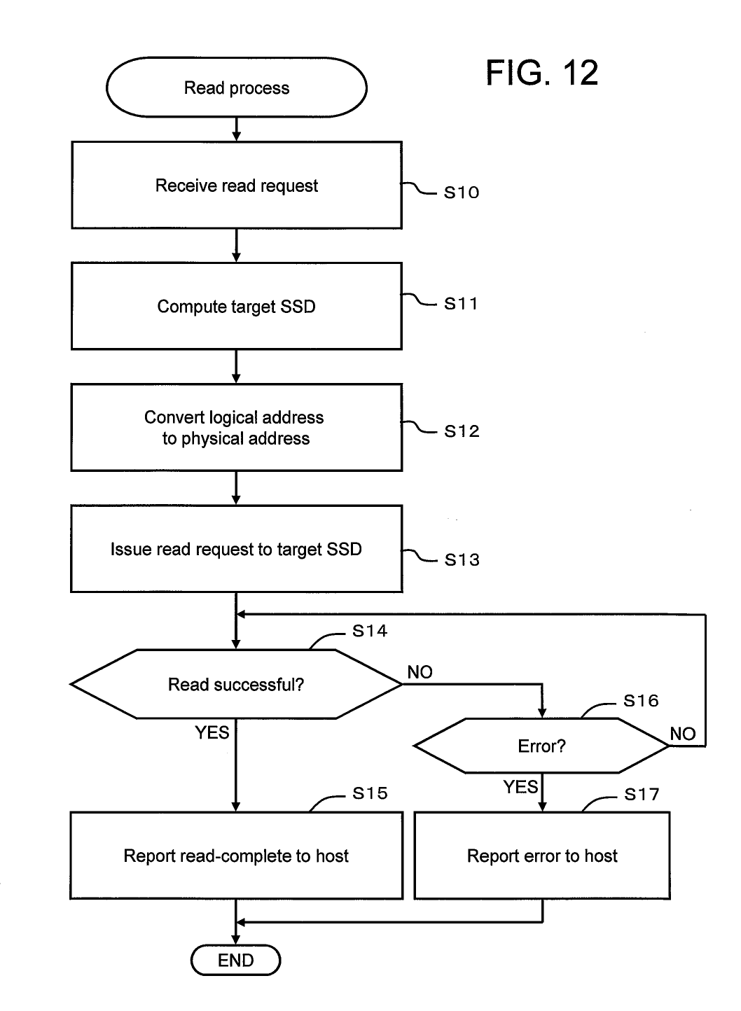

FIG. 12 is a flowchart showing a read process. Each of the below processes is executed by the controller 100 of the storage control apparatus 10. Specifically, each of the following processes is realized in accordance with the microprocessor 130 reading and executing a prescribed computer program P10 inside the memory 140. Therefore, the doer of the action for explaining the operations of the flowchart may be any of the storage control apparatus 10, the controller 100, the microprocessor 130, or the computer program P10.

The controller 100 receives a read request from the host 20 (S10). A first logical address and a data size are stored in the read request. The controller 100 computes the read-targeted storage device 210 (SSD) based on the read request (S11).

The controller 100 converts the logical address into a physical address (S12) and issues a read request to the read-targeted storage device 210 (S13). The read request from the controller 100 is sent to the read-targeted storage device 210 via the BE I/F 120. The read-targeted storage device 210 reads the requested data and transfers this data to the controller 100. The BE I/F 120 stores the data received from the storage device 210 in the cache memory 140. The storage device 210 notifies the controller 100 as to whether or not the read request was processed normally.

The controller 100 determines whether the data read from the storage device 210 was successful (S14). In a case where the data read succeeded (S14: YES), the controller 100 notifies the host 20 to the effect that the read request was processed normally, and, in addition, sends the data stored in the cache memory 140 to the host 20 from the FE I/F 110 (S15).

In a case where the data read from the storage device 210 failed (S14: NO), the controller 100 determines whether or not an error occurred (S16). In a case where either a read error or a BAD occurred (S16: YES), the controller 100 reports to the host 20 that the read request process failed (S17). In a case where an error did not occur (S16: NO), for example, a case in which the storage device 210 has a backlog, the controller 100 returns to S14.

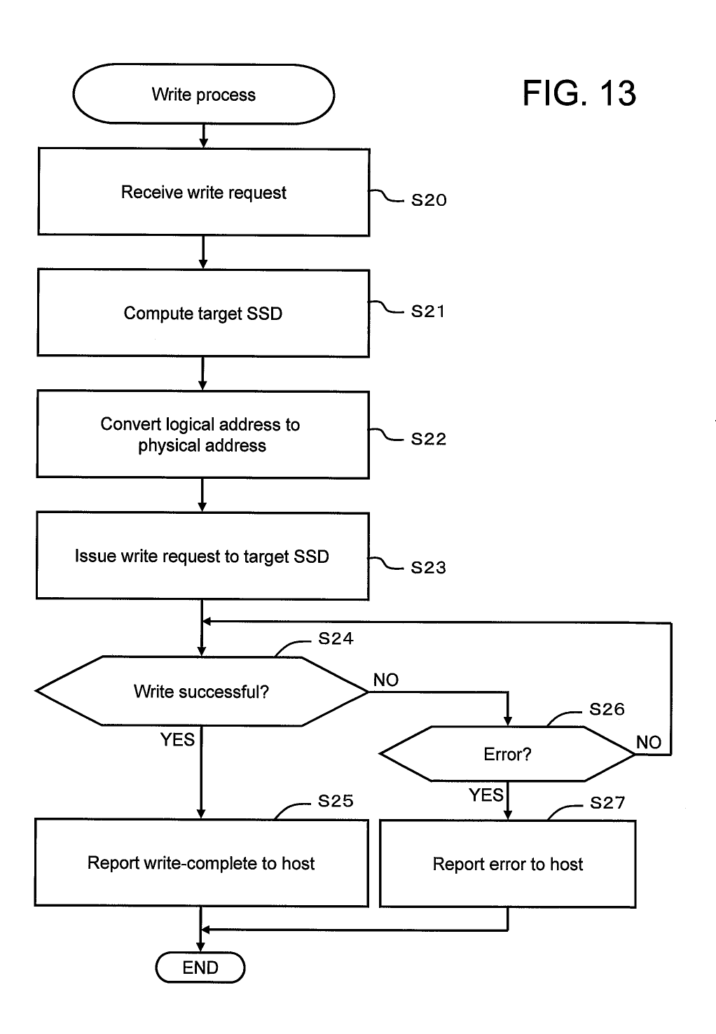

FIG. 13 is a flowchart showing a write process. The controller 100, upon receiving a write request and write data from the host 20 (S20), analyzes this write request and identifies the write-targeted storage device 210 (S21).

The controller 100 converts a logical address specified in the write request to a physical address (S22) and issues a write request to the write-targeted storage device 210 (S23). The storage device 210, upon receiving the write request from the controller 100, writes the write data to the specified physical address. The storage device 210 notifies the controller 100 as to whether or not the write request was processed normally.

The controller 100 determines whether the write request was processed normally (S24). In a case where the write request was processed normally (S24: YES), the controller 100 reports to the host 20 that the write request was processed normally (S25).

In a case where the write request was not processed normally in the storage device 210 (S24: NO), the controller 100 determines whether or not a write error occurred (S26). In a case where a write error occurred (S26: YES), the controller 100 notifies the host 20 that the write request process failed (S27). In a case where a write error did not occur (S26: NO), the controller 100 returns to S24.

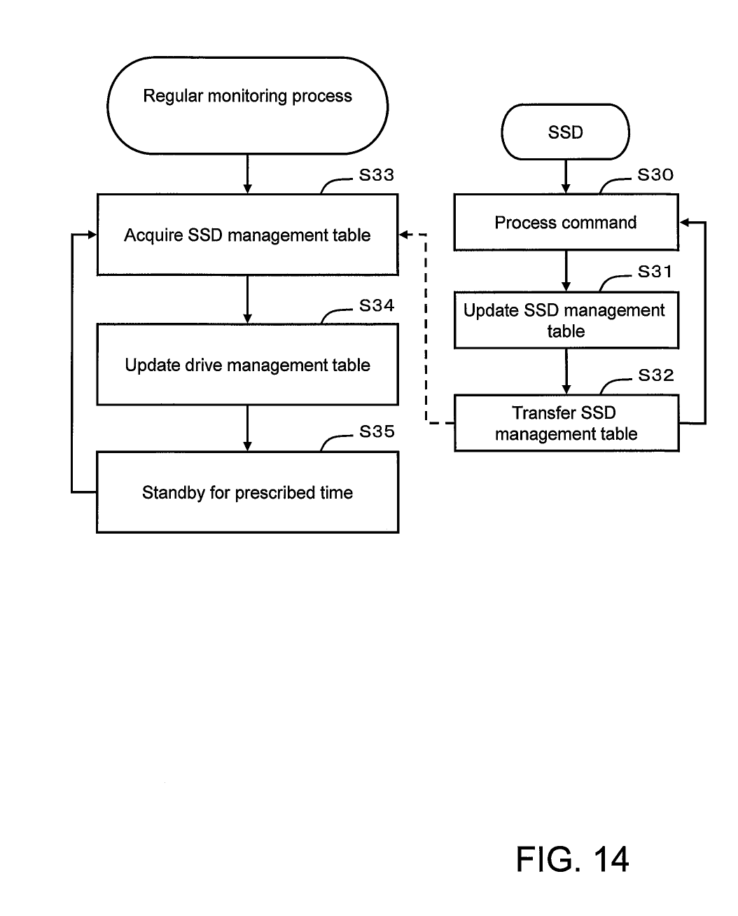

FIG. 14 is a flowchart showing a regular monitoring process. Each storage device 210 processes a command (a request) received from the controller 100 (S30), and updates the SSD management table T30 in accordance with the result of this processing (S31). The storage device 210 transfers the SSD management table T30 to the controller 100 at a prescribed cycle (S32).

The controller 100, upon receiving the SSD management table T30 from each storage device 210 (S33), updates the drive management table T20 based on the contents of the SSD management table T30 (S34). The controller 100 stands by for a prescribed time period (S35), and acquires the SSD management table T30 from each storage device 210 once again (S33).

Furthermore, when updating the drive management table T20 in S34, the controller 100 may revise the first threshold Th1 based on the latest access history.

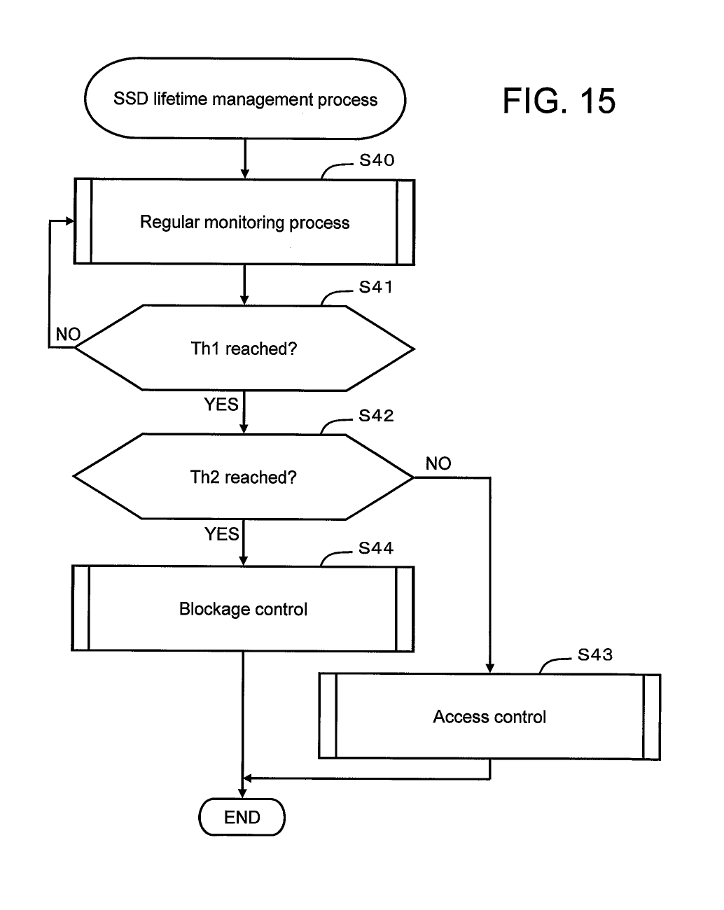

FIG. 15 is a flowchart showing the process for managing the lifetime of the storage device 210. The controller 100 executes the regular monitoring process explained using FIG. 14 and updates the drive management table T20 (S40).

The controller 100, based on the latest drive management table T20, determines whether there is a storage device 210 for which the value of the monitoring-targeted state has reached the first threshold Th1 (S41). For convenience of explanation, such a storage device 210 will be called a first storage device 210. When a first storage device 210 is discovered (S41: YES), the controller 100 determines whether there is a storage device (a first storage device) for which the value of the monitoring-targeted state has reached the second threshold Th2 (S42).

In a case where a first storage device 210 exists (S41: YES), but the value of the monitoring-targeted state of this first storage device 210 has not reached the second threshold Th2 (S42: NO), the controller 100 executes access control (S43). Access control corresponds to the processing executed by the period adjusting part 1G of FIG. 1. The access control will be explained in detail further below.

In a case where there is a storage device 210 for which the value of the monitoring-targeted state has reached the second threshold Th2 (S42: YES), the controller 100 executes blockage control (S44). Blockage control corresponds to the processing executed by the blockage processing part 1H of FIG. 1. The blockage control will be explained in detail further below.

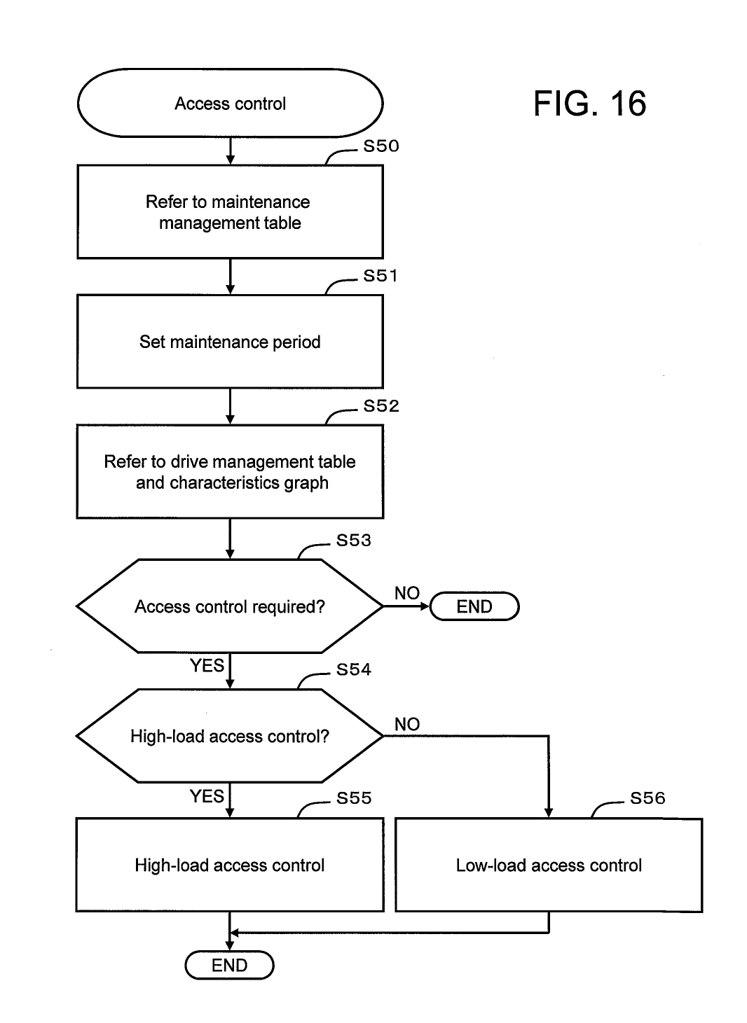

FIG. 16 is a flowchart of the access control processing shown in S43 of FIG. 15. The controller 100 refers to the maintenance management information table T40 (S50). The controller 100 acquires the maintenance period, which has been inputted to the maintenance setup screen G10, and sets the maintenance period in the maintenance management information table T40 (S51).

The controller 100 refers to the drive management table T20 and the characteristics graph T60 (S52), and determines whether or not it is necessary to execute access control (S53). For example, access control is not necessary in the case of a storage device comprising a maintenance period, which is substantially identical to the criterial maintenance period MT1 (the maintenance period of the medium-quality storage device for this model, which may also be called life expectancy.).

Access control is necessary in the case of a storage device 210 comprising a maintenance period, which differs from the criterial maintenance period MT1 by a value that is equal to or larger than a prescribed value. This is to make the maintenance replacement timing uniform. Or, access control is necessary to make complete use of the lifetime of the storage device 210.

As was explained using FIG. 11, there will be variations in quality even among storage devices of the same model, and the actual lifetime of a storage device will differ in accordance with the variations in quality. A high-quality storage device 210 of the relevant model will have a longer lifetime than a reference storage device (a medium-quality storage device). By contrast, a low-quality storage device 210 of the relevant model will have a shorter lifetime than a reference storage device.

Consequently, for a storage device 210 with a lifetime that is shorter than a reference lifetime (the reference maintenance period MT1) that serves as the “criterial period”, low-load access control, which will be described further below, is executed, and the lifetime of this storage device 210 is extended to approach that of the reference lifetime. In accordance with this, the maintenance period MT2 of a relatively low-quality storage device can be made identical to the maintenance period MT1 of a reference quality storage device, enabling maintenance replacement to be carried out simultaneously.

For a high-quality storage device 210 comprising a lifetime that is longer than the reference lifetime, a high-load access control, which will be described further below, is executed to utilize the high-quality storage device 210 more frequently than before. The storage device steadily deteriorates and its lifetime becomes shorter the more this storage device is used, that is, the more data is written to and erased from this storage device.

Consequently, increasing the frequency of accesses to the high-quality storage device 210 to a higher access frequency than before shortens the lifetime of the high-quality storage device 210, thereby making this lifetime identical to the maintenance period MT1 of the reference quality storage device.

In a case where the lifetime of the high-quality storage device 210 is not adjusted using the access control process, the high-quality storage device 210 will be replaced together with the other storage devices despite the fact that this storage device 210 has a long lifetime remaining. Replacing a storage device which has a long lifetime remaining increases operating costs. Therefore, in this example, access is focused on the high-quality storage device 210 to enable the lifetime to be used economically.

Return to FIG. 16. The controller 100 determines whether the high-load access control process is to be carried out (S54) in a case where a determination has been made that the access control process is necessary (S53: YES), that is, a case in which it has been determined that the difference between the reference maintenance period and the life expectancy is equal to or larger than a prescribed value.

As described hereinabove, the access control process is for adjusting a lifetime. The high-load access control process is executed with respect to a storage device which has been determined to have a lifetime (MT3) that is longer than the reference lifetime (MT1) (S55). This process is for making as effective use as possible of this storage device 210 until the end of its lifetime.

A low-load access control process is executed with respect to a storage device which has been determined to have a lifetime (MT2) that is shorter than the reference lifetime (MT1) (S56). This process is for extending the lifetime of a low-quality storage device and making the replacement time the same as the replacement time of the other storage devices, thereby enhancing the efficiency of the maintenance work.

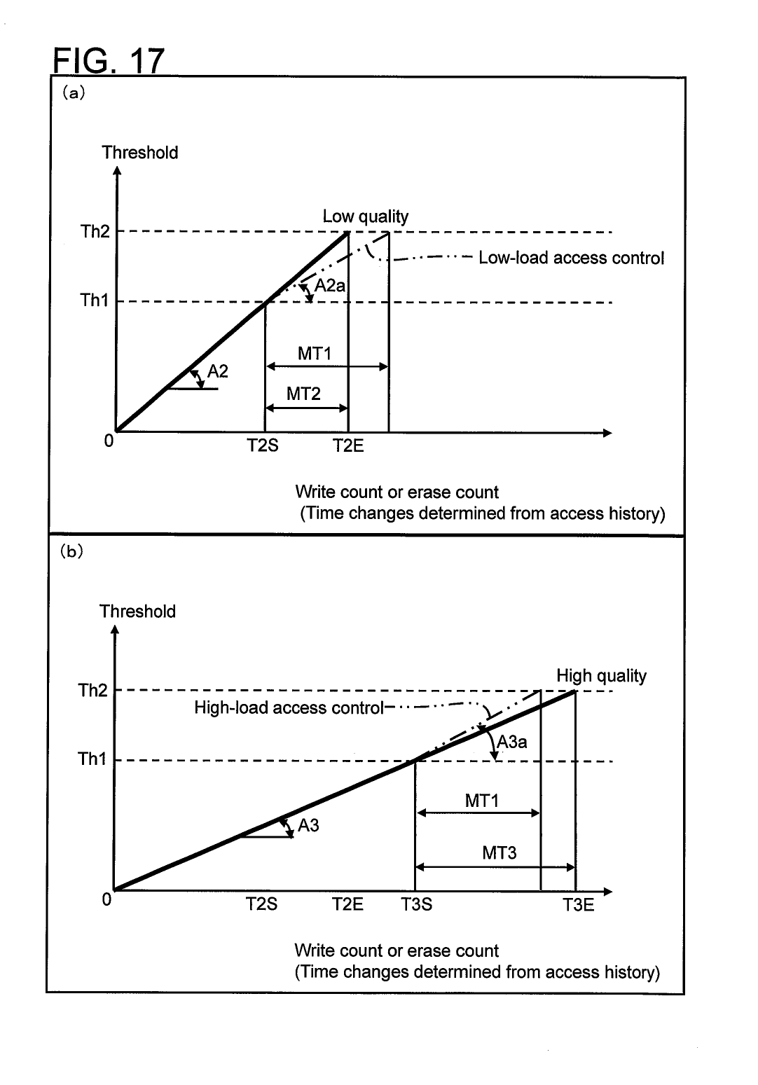

FIG. 17 shows schematic representations of the access control process. FIG. 17 (a) shows a case in which the low-load access control process is executed with respect to a low-quality storage device. At the point in time when the value of a prescribed utilization state of the low-quality storage device has reached the first threshold Th1, a gradient A2 can be computed from the increment C204 of the drive management table T20. Based on this gradient A2, it is possible to compute the period MT2 until the low-quality storage device reaches the second threshold Th2.

In a case where the difference between the maintenance period MT2 of the low-quality storage device and the maintenance period MT1 of the reference quality storage device is equal to or larger than a prescribed value, the controller 100 executes the low-load access control process with respect to the low-quality storage device to lower the frequency with which the low-quality storage device is accessed. The gradient of the low-quality storage device characteristics graph increases from A2 to A2a (where A2a>A2). As a result of this, the maintenance period MT2 of the low-quality storage device approaches the reference maintenance period MT1.

FIG. 17 (b) shows a case where a high-load access control process is executed with respect to a high-quality storage device. At the point in time when the value of a prescribed utilization state of the high-quality storage device has reached the first threshold Th1, a gradient A3 can be determined from the increment C204 of the drive management table T20. Based on this gradient A3, it is possible to compute the period MT3 until the high-quality storage device reaches the second threshold Th2.

In a case where the difference between the maintenance period MT3 of the high-quality storage device and the reference quality maintenance period MT1 is equal to or larger than a prescribed value, the controller 100 executes the high-load access control process with respect to the high-quality storage device to increase the frequency with which the high-quality storage device is accessed. The gradient of the high-quality storage device characteristics graph decreases from A3 to A3a (where A3a<A3). As a result of this, the maintenance period MT3 of the high-quality storage device approaches the reference maintenance period MT1.

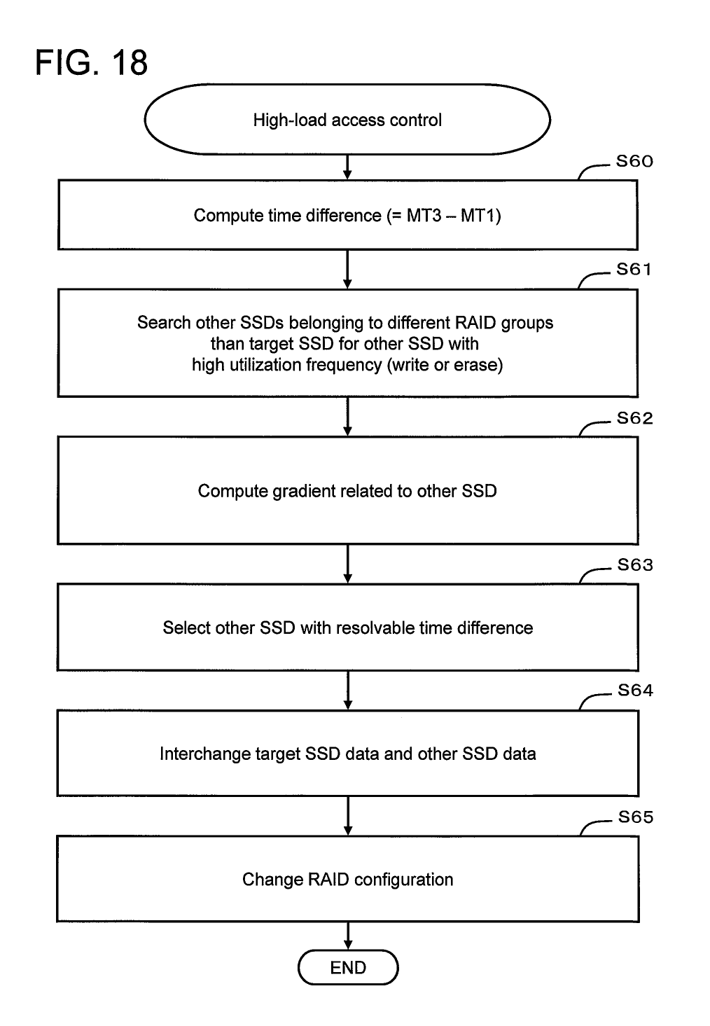

FIG. 18 is a flowchart of the high-load access control process. FIG. 18 shows the details of S55 in FIG. 16. Hereinafter, the processing-targeted storage device (the high-quality storage device) will be called the target storage device. This is abbreviated as target SSD in the drawings.

The controller 100 computes the time difference by subtracting the reference maintenance period MT1 from the maintenance period MT3 of the target storage device (S60).

The controller 100 searches for a storage device having a utilization frequency (access frequency) that is higher than the target storage device in all of the RAID groups that differ from the RAID group to which the target storage device belongs (S61). For ease of understanding, a different storage device than the target storage device will be called the other storage device. In a case where not one other storage device with a higher access frequency than the target storage device can be found, the high-load access control process cannot be executed and this processing ends.

The controller 100 refers to the drive management table T20 and the characteristics map T60, and computes the respective gradients for the one or multiple other storage devices detected in S61 (S62). The controller 100, based on the gradient(s) computed in S62, selects the one other storage device for which the time difference computed in S60 is most resolvable (S63).

The controller 100 interchanges data between the selected other storage device and the target storage device (S64). In addition, the controller 100 changes the RAID groups to which the selected other storage device and the target storage device belong (S65).

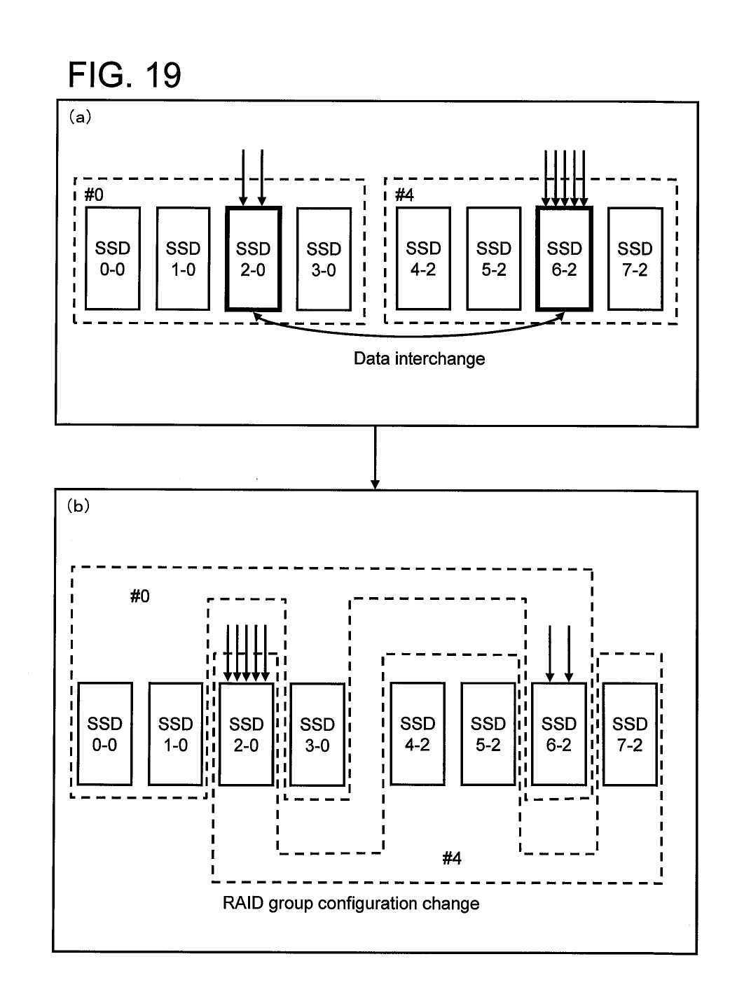

FIG. 19 is an illustrative drawing showing how to interchange data between storage devices, and, in addition, how to change the RAID groups to which the storage devices belong. In FIG. 19, it is assumed that the access frequency of the storage device (6-2) is higher than the access frequency of the storage device (2-0). In the case of the high-load access control process, the storage device (2-0) is equivalent to the target storage device, and the storage device (6-2) is equivalent to the other storage device.

As shown in FIG. 19 (a), the data inside the target storage device (2-0) is interchanged with the data of the other storage device (6-2). Either an unused storage device or the cache memory 140 may be used for the data interchange.

As shown in FIG. 19 (b), the RAID group to which the target storage device (2-0) belongs changes from the current RAID group (#0) to RAID group (#4), to which the other storage device (6-2) belongs. At the same time, the RAID group to which the other storage device (6-2) belongs changes from the current RAID group (#4) to RAID group (#0), to which the target storage device (2-0) belongs. The RAID groups to which the target storage device (2-0) and the other storage device (6-2) belong are changed like this.

As a result of this, data for which the access frequency is high is stored in the target storage device (2-0), thereby shortening the lifetime (MT3). Therefore, it is possible to prevent the target storage device (2-0) from being replaced while a long lifetime still remains, thereby reducing the operating costs of the storage control apparatus 10.

In the case of the low-load access control process, contrary to the above explanation, the storage device (6-2) with the high access frequency is equivalent to the target storage device and the storage device (2-0) with the low access frequency is equivalent to the other storage device.

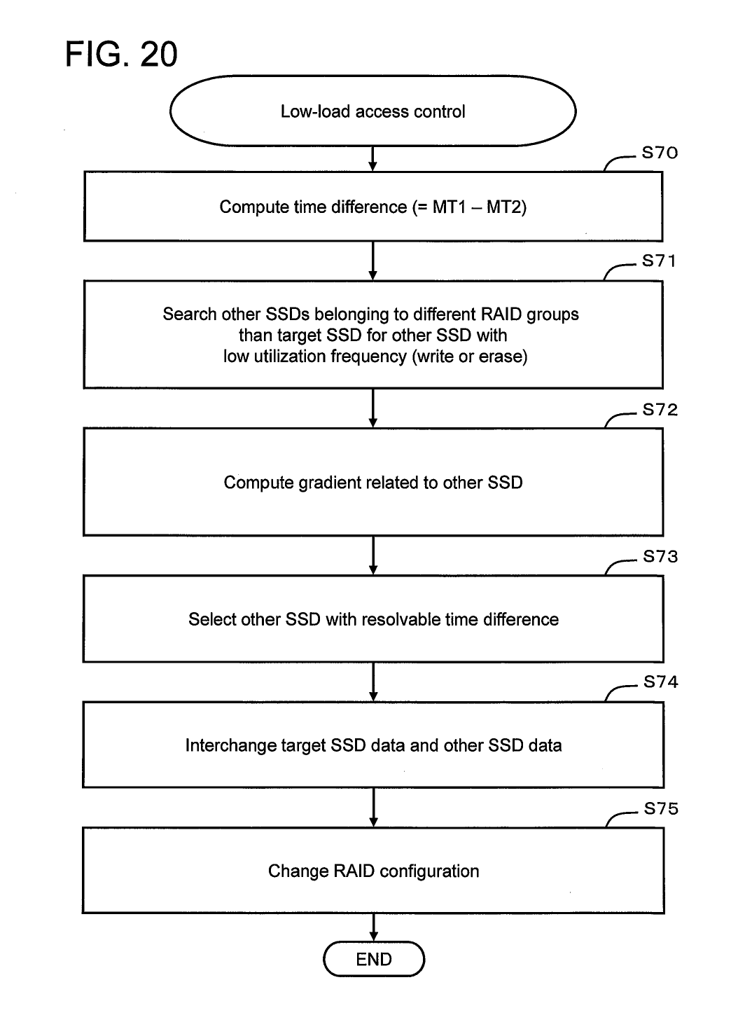

FIG. 20 is a flowchart showing the low-load access control process. FIG. 20 shows the details of S56 in FIG. 16.

The controller 100 computes the time difference by subtracting the maintenance period MT2 of the target storage device from the reference maintenance period MT1 (S70).

The controller 100 searches for a storage device having an access frequency that is lower than the target storage device in all of the RAID groups that differ from the RAID group to which the target storage device belongs (S71). In a case where not one other storage device with a lower access frequency than the target storage device can be found, the low-load access control process cannot be executed and this processing ends.

The controller 100 refers to the drive management table T20 and the characteristics map T60, and computes the respective gradients for the one or multiple other storage devices detected in S71 (S72). The controller 100, based on the gradient(s) computed in S72, selects the one other storage device for which the time difference computed in S70 is most resolvable (S73).

The controller 100 interchanges data between the selected other storage device and the target storage device (S74). In addition, the controller 100 changes the RAID groups to which the selected other storage device and the target storage device belong (S75).

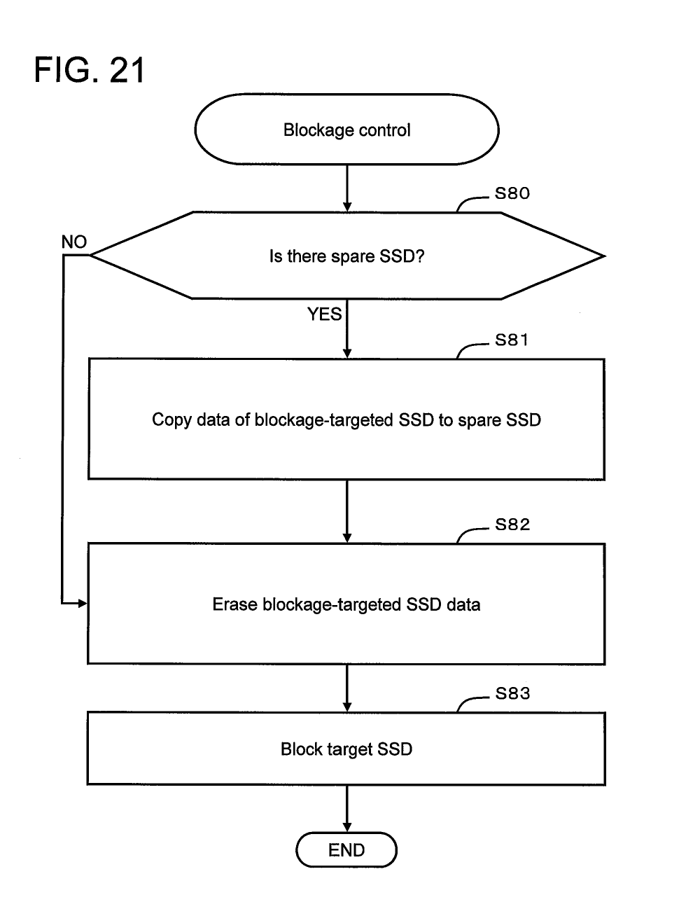

FIG. 21 is a flowchart of the blockage control process. FIG. 21 shows the details of S44 in FIG. 15. First of all, the controller 100 determines whether or not a spare storage device 210 exists (S80). A spare storage device 210 is an unused storage device. It is preferable that the spare storage device 210 comprise a storage size, which is the same of larger than that of the blockage-targeted storage device. However, multiple unused storage devices with small storage sizes may be used as the spare storage device.

The controller 100 copies the data of the blockage-targeted storage device 210 to the spare storage device (S81). After completing the copying of S81, the controller 100 sends a data erase command to the blockage-targeted storage device 210, and erases all the data stored in the blockage-targeted storage device 210 (S82).

The controller 100 blocks the blockage-targeted storage device 210 and separates this storage device 210 from the system (S83). A user, such as the system administrator, removes the blocked storage device 210 from the drive box 200, and replaces this with a new storage device. The controller 100 copies the data stored in the spare storage device to the new storage device.

In this example, which is configured like this, the access control process for adjusting the maintenance period starts when the value of the prescribed utilization state of the storage device 210 reaches the first threshold Th1. Therefore, the maintenance replacement times of the storage devices inside the same RAID group can be made identical, making it possible to enhance maintenance work efficiency.

In this example, the high-load access control process is executed with respect to a high-quality storage device, which has a longer maintenance period than the reference maintenance period (the criterial period). This makes it possible to focus accesses on the high-quality storage device to make economical use of the lifetime. It is therefore possible to reduce the operating costs of the storage control apparatus 10.

In this example, after using the storage device until the value of the prescribed utilization state reaches the second threshold, the storage device is blocked. Therefore, the maintenance replacement of the storage device can be carried out systematically. As a result of this, it is possible to prevent the storage device from suddenly stopping, thereby enhancing the reliability of the storage control apparatus 10.

In this example, each storage device can be used until the maintenance period, and multiple storage devices can be replaced at the same time. Therefore, the frequency of maintenance replacement work can be lowered, thereby making it possible to reduce the operating costs of the storage control apparatus 10.

In this example, the maintenance replacement of storage devices is carried out systematically, thereby making it possible to remove a storage device after using the data erase command to erase the data inside the storage device. Therefore, it is not necessary to physically destroy a storage device for security purposes, thereby enabling the reuse of the flash memory and so forth inside the storage device.

### Example 2

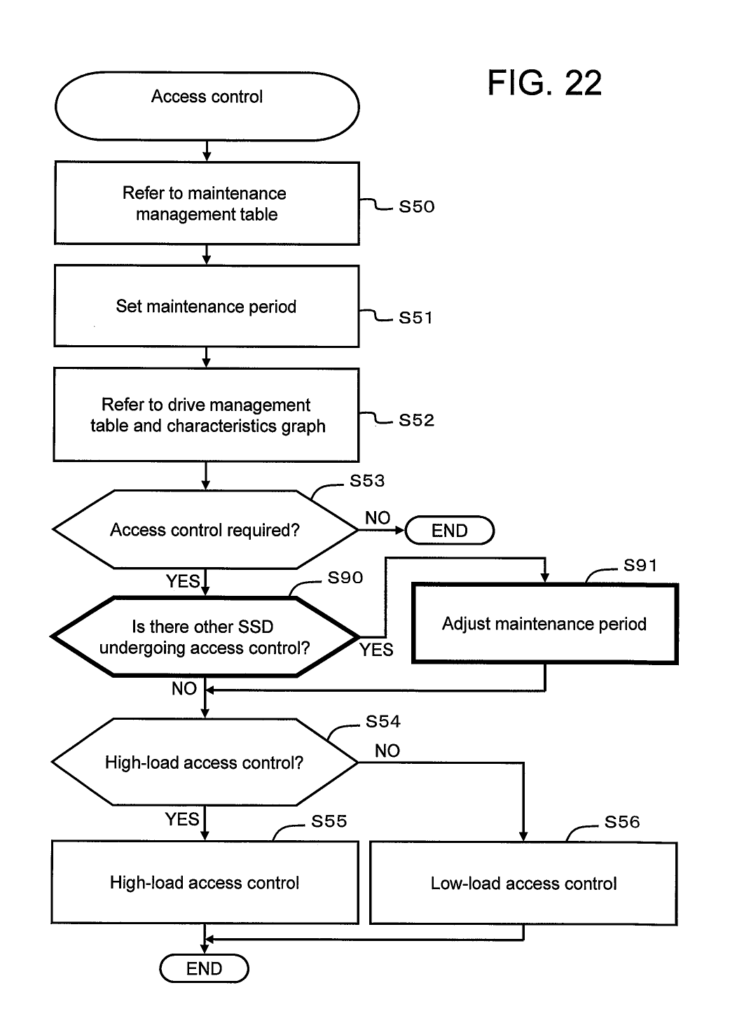

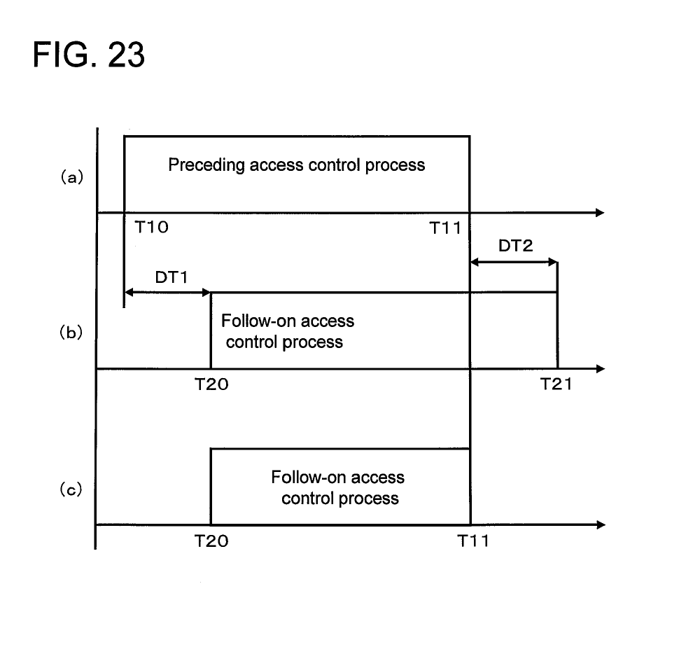

A second example will be explained by referring to FIGS. 22 and 23. Since this example is equivalent to a variation of the first example, the explanation will focus on the differences with the first example. In this example, an adjustment will be explained in a case where subsequent to an access control process being started for one storage device 210 another access control process is started for another storage device 210.

FIG. 22 is a flowchart of an access control process in accordance with this example. This process comprises all of Steps S50 through S56 of the processing shown in FIG. 16. In addition, new Steps S90 and S91 are disposed between S53 and S54 in this process. Consequently, the new Steps S90 and S91 will be explained.

The controller 100, upon making a determination that it is necessary to execute the access control process (S53: YES), determines whether or not another storage device for which the access control process is already being executed exists in another RAID group 230 (S90).

In a case where an access control process is not being executed in another RAID group 230 (S90: NO), the controller 100 determines whether or not a high-load access control process is to be executed as described using FIG. 16 (S54). The controller 100 executes either the high-load access control process (S55) or the low-load access control process (S56).

In a case where the access control process is already being executed with respect to another storage device 210 in another RAID group 230, the controller 100 is able to adjust the maintenance period (S91).

That is, in a case where an access control process is already underway in the one RAID group, the access control process in the other RAID group can be adjusted in accordance with the preceding access control process.

FIG. 23 shows how to adjust a follow-on access control process in accordance with a preceding access control process. As shown in FIG. 23 (a), one access control process has been started earlier at time T10. It is supposed that the end time for this access control process is T11. The end time T11 is the termination of the maintenance period, which this access control process is attempting to adjust.

As shown in FIG. 23 (b), a case in which another access control process (a follow-on access control process) is started at time T20, which is delayed by time DT1 from the start time T10 of the preceding access control process, will be considered. It is supposed that the follow-on access control process will adjust substantially the same maintenance period (for example, one week, one month) as that of the preceding access control process. It is supposed that the end time of the follow-on access control process is T21, which is time DT2 after the end time T11 of the preceding access control process.

As shown in FIG. 23 (a), the preceding access control process ends at time T11, and the storage device is replaced. The follow-on access control process also ends after the passage of time DT2, and the other storage device is replaced. In a case where the time DT2 is short, the system administrator or other user must replace two storage apparatuses within a short period of time, and this is troublesome.

Consequently, as shown in FIG. 23 (c), the maintenance period of the follow-on access control process is shortened by time DT2 more than the original value. As a result of this, the end time of the follow-on access control process maintenance period approaches the end time T11 of the preceding access control process. Therefore, the storage device, which is the target of the preceding access control process, and the other storage device, which is the target of the follow-on access control process, can be replaced simultaneously, thereby enhancing maintenance work efficiency.

Whether or not the maintenance period will be adjusted by the follow-on access control process can be determined in accordance with the length of the time difference DT2 with the end time T11 of the preceding access control process as described above. In a case where the DT2 is shorter than a prescribed time, the follow-on access control process adjusts the maintenance period. However, the configuration may also be such that in a case where there is a lack of spare storage devices, for example, the access control process does not adjust the maintenance period.

Configuring this example like this achieves the same effects as the first example. In addition, in this example, since maintenance periods are adjusted between a preceding access control process and an follow-on access control process related to respectively different RAID groups, it is also possible to collectively carry out the maintenance replacement of storage devices in different RAID groups.

Furthermore, the present invention is not limited to the above-described embodiment. A so-called person with ordinary skill in the art will be able to change or delete a portion of the configuration described in the embodiment, add a new configuration, and think of another configuration for achieving the object of the present invention. These configurations are also included within the scope of the present invention.

### REFERENCE SIGNS LIST

1, 10 Storage control apparatus
2, 20 Host computer
3 Management terminal
30 Maintenance terminal
1A, 210 Storage device
230 RAID group

1. A storage control apparatus, which controls multiple semiconductor-type storage devices,
the storage control apparatus comprising:
a microprocessor;
a memory used by the microprocessor;
a first communication interface circuit for communicating with a host computer; and
a second communication interface circuit for communicating with the multiple storage devices, wherein
the microprocessor, in accordance with executing a prescribed computer program stored in the memory, establishes respectively:
a utilization stat management part for managing utilization states of the multiple storage devices;
a period adjusting part for extracting from among the multiple storage devices a first storage device, which matches a preset first state, and controlling a prescribed period during which the extracted first storage device reaches a preset second state, based on the utilization states of the multiple storage devices managed by the utilization state management part; and
a blockage processing part for extracting from among the multiple storage devices a second storage device, which matches the second state, and blocking the extracted second storage device.

2. A storage control apparatus according to claim 1, wherein the period adjustment part extracts multiple first storage devices from among the multiple storage devices in preset group units, and controls the prescribed period for each of the multiple first storage devices extracted in the group units.

3. A storage control apparatus according to claim 2, wherein the period adjusting part determines whether the prescribed period, during which the first storage device reaches the second state, is earlier or later than a preset reference period,
in a case where the prescribed period is later than the reference period, executes a first control process for controlling the utilization state of the first storage device
to expedite the prescribed period, and in a case where the prescribed period is earlier than the reference period, executes a second control process for controlling the utilization state of the first storage device to delay the prescribed period.

4. A storage control apparatus according to claim 3, wherein the period adjusting part, in a case where either the first control process or the second control process is being executed with respect to another first storage device, executes either the first control process or the second control process with respect to the first storage device such that another prescribed period with respect to the other first storage device is identical to the prescribed period with respect to the first storage device.

5. A storage control apparatus according to claim 4, wherein the first control process further increases a first storage device utilization frequency by the host computer, and the second control process further decreases a first storage device utilization frequency by the host computer.

6. A storage control apparatus according to claim 5, wherein
the first control process detects another storage device, which has a higher utilization frequency than the first storage device, and interchanges data between the other storage device with the higher utilization frequency and the first storage device, and
the second control process detects another storage device, which has a lower utilization frequency than the first storage device, and interchanges data between the other storage device with the lower-utilization-frequency and the first storage device.

7. A storage control apparatus according to claim 6, wherein
the first control process changes the RAID groups to which the first storage device and the other storage device with the higher utilization frequency respectively belong, and
the second control process changes the RAID groups to which the first storage device and the other storage device with the lower utilization frequency respectively belong.

8. A storage control apparatus according claim 1, wherein the blockage process blocks the second storage device after erasing data stored in the second storage device.

9. A storage control apparatus according to claim 8, wherein the blockage process erases data stored in the second storage device after copying the data stored in the second storage device to a spare storage device, and thereafter blocks the second storage device.

10. A storage control apparatus according claim 1, wherein
from among the multiple storage devices a storage device for which a prescribed utilization state has reached a preset first threshold is selected as the first storage device matching the first state, and
from among the multiple storage devices a storage device for which the prescribed utilization state has reached a preset second threshold is selected as the second storage device matching the second state.

11. A storage control apparatus according to claim 10, wherein
the second threshold is set beforehand corresponding to a type of the multiple storage devices, and
the first threshold is set based on the history of the utilization state, a specified maintenance period, and the second threshold.

12. A storage control apparatus according to claim 11, wherein either all or a portion of preset multiple indicators can be selected as the utilization states.

13. A storage control apparatus according to claim 12, wherein the multiple indicators include, in plurality, any of an erase count, a read error count, a write error count, and a number of pages for which data cannot be read.

14. A method of managing lifetimes of multiple semiconductor-type storage devices in accordance with a storage control apparatus, wherein
the storage control apparatus has:
a microprocessor; and
a memory, which is used by the microprocessor, and
in accordance with the microprocessor carrying out a prescribed computer program stored in the memory, the method executes:
managing the utilization states of the multiple storage devices;
setting a second threshold corresponding to a type of the multiple storage devices;
setting a first threshold based on a utilization state history, a specified maintenance period, and the second threshold;
determining whether or not a first storage device, for which a utilization state value has reached the first threshold, exists among the multiple storage devices;
computing, in a case where the first storage device exists, a prescribed period until the utilization state value of the first storage device reaches the second threshold;
comparing the computed the prescribed period with a preset reference period;
executing, in a case where the prescribed period is later than the reference period, a first control process for controlling the utilization state value of the first storage device to expedite the prescribed period;
executing, in a case where the prescribed period is earlier than the reference period, a second control process for controlling the utilization state value of the first storage device to delay the prescribed period;
determining whether or not a second storage device, for which the utilization state value has reached the second threshold, exists among the first storage devices;
erasing, in a case where the second storage device exists, data inside the second storage device; and
blocking the second storage device from which the data has been erased.
